(19) United States
(12) Patent Application Publication
(10) Pub. No.: US 2026/0255356 A1
(43) Pub. Date: Aug. 27, 2026

(54) METHOD AND APPARATUS FOR RECEIVING PHYSICAL DOWNLINK CONTROL CHANNEL, AND METHOD AND APPARATUS FOR SENDING PHYSICAL DOWNLINK CONTROL CHANNEL

(71) Applicant: Beijing Xiaomi Mobile Software Co., Ltd., Beijing (CN)

(72) Inventor: Yajun ZHU, Beijing (CN)

(73) Assignee: Beijing Xiaomi Mobile Software Co., Ltd., Beijing (CN)

(21) Appl. No.: 18/857,763

(22) PCT Filed: Apr. 18, 2022
(86) PCT No.: PCT/CN2022/087507

§ 371 Date: Oct. 17, 2024

(51) Int. Cl. H04W 72/23; H04W 72/50

(52) U.S. Cl. CPC H04W 72/23; H04W 72/535

(57) ABSTRACT

A method, apparatus, and computer readable medium for receiving and/or transmitting a physical downlink control channel (PDCCH). The PDCCH is transmitted/received by: determining a first resource, which is occupied by an indicator channel in a long term evolution (LTE) system, and a second resource, which is occupied by a new radio PDCCH (NR PDCCH); when there is a collision between the second resource and the first resource, determining a manner in which the NR PDCCH is received; and receiving the NR PDCCH.

### CROSS REFERENCE TO RELATED APPLICATIONS

This application is a US National Phase of a PCT Application No. PCT/CN2022/087507 filed on Apr. 18, 2022, the entire contents of which are incorporated herein by reference in their entireties.

### TECHNICAL FIELD

The present disclosure relates to the field of communication technology, and in particular to physical downlink control channel receiving methods, physical downlink control channel transmitting methods, physical downlink control channel receiving apparatuses, physical downlink control channel transmitting apparatuses, communication devices, and computer-readable storage media.

### BACKGROUND

At present, in the DS S (Dynamic Spectrum Sharing) scenario, LTE (Long Term Evolution) system and NR (New Radio) system can coexist on the same spectrum, which leads to interference from some information transmitted by LTE system to NR system.

For example, when the RE (Resource Element) for PCFICH (Physical Control Format indicator channel) or PHICH (Physical Hybrid ARQ (Automatic Repeat request) indicator channel) transmitted by LTE system conflicts with the RE for NR PDCCH (Physical Downlink Control Channel), there will be interference when the terminal receives NR PDCCH on the conflicting RE, which will reduce the demodulation performance for NR PDCCH.

### SUMMARY

In view of this, the embodiments of the present disclosure propose physical downlink control channel receiving methods, physical downlink control channel transmitting methods, physical downlink control channel receiving apparatuses, physical downlink control channel transmitting apparatuses, communication devices, and computer-readable storage media, to solve a technical problem in related arts.

According to the first aspect of the embodiments of the present disclosure, a physical downlink control channel receiving method is provided, performed by a terminal, and includes: determining a first resource occupied by an indicator channel in a long term evolution (LTE) system and a second resource occupied by a new radio (NR) physical downlink control channel (PDCCH); determining, in response to a conflict between the second resource and the first resource, a receiving manner for the NR PDCCH; and receiving the NR PDCCH according to the receiving manner;
where the receiving manner includes at least one of: a first receiving manner: receiving based on puncturing of the NR PDCCH by a network device according to the first resource; or a second receiving manner: receiving based on rate matching of the NR PDCCH by a network device according to the first resource.

According to the second aspect of the embodiments of the present disclosure, a physical downlink control channel transmitting method is provided, performed by a network device, and includes: determining a first resource occupied by an indicator channel in a long term evolution (LTE) system and a second resource occupied by a new radio (NR) physical downlink control channel (PDCCH); determining, in response to a conflict between the second resource and the first resource, a transmitting manner for the NR PDCCH; and transmitting the NR PDCCH according to the transmitting manner;
where the transmitting manner includes at least one of: a first transmitting manner: puncturing the NR PDCCH based on the first resource; or a second transmitting manner: performing rate matching (RM) on the NR PDCCH based on the first resource.

According to the third aspect of the embodiments of the present disclosure, a physical downlink control channel receiving device is proposed, suitable for a terminal, including: a processing module configured to determine the first resource occupied by the indicator channel in the Long Term Evolution LTE system, and the second resource occupied by the New Radio physical downlink control channel NR PDCCH; Determine the receiving manner for the NR PDCCH in the event of a conflict between the second resource and the first resource; A receiving module configured to receive the NR PDCCH according to the receiving manner;
where the receiving manner includes at least one of: a first receiving manner: receiving based on puncturing of the NR PDCCH by a network device according to the first resource; or a second receiving manner: receiving based on rate matching of the NR PDCCH by a network device according to the first resource.

According to the fourth aspect of the embodiments of the present disclosure, a physical downlink control channel receiving apparatus is provided, applied to a terminal, and includes: a processing module, configured to: determine a first resource occupied by an indicator channel in a long term evolution (LTE) system and a second resource occupied by a new radio (NR) physical downlink control channel (PDCCH); and determine, in response to a conflict between the second resource and the first resource, a receiving manner for the NR PDCCH; and a receiving module, configured to receive the NR PDCCH according to the receiving manner;
where the transmitting manner includes at least one of: a first transmitting manner: puncturing the NR PDCCH based on the first resource; or a second transmitting manner: performing rate matching (RM) on the NR PDCCH based on the first resource.

According to the fifth aspect of the embodiments of the present disclosure, a communication device is proposed, including: one or more processors; and one or more memories for storing a computer programs; where when the computer program is executed by the one or more processors, the physical downlink control channel receiving method described above is implemented.

According to the sixth aspect of the embodiments of the present disclosure, a communication device is proposed, including: one or more processors; and one or more memories for storing a computer programs; where when the computer program is executed by the one or more processors, the physical downlink control channel transmitting method described above is implemented.

According to the seventh aspect of the present embodiments of the present disclosure, a computer-readable storage medium is proposed for storing a computer program, where when the computer program is executed by one or more processors, the physical downlink control channel receiving method described above is implemented.

According to the eighth aspect of the present embodiments of the present disclosure, a computer-readable storage medium is proposed for storing a computer program, where when the computer program is executed by one or more processors, the physical downlink control channel transmitting method described above is implemented.

According to the embodiments of the present disclosure, in response to a conflict between the first resource occupied by the LTE indicator channel and the second resource occupied by the NR PDCCH, the NR PDCCH is received through either the first receiving manner or the second receiving manner, which can alleviate the problems caused by the conflict between the first resource and the second resource, which is beneficial for improving the system capacity for the NR PDCCH and enhancing the performance of the NR system.

### BRIEF DESCRIPTION OF DRAWINGS

In order to more clearly illustrate the technical solutions according to the embodiments of the present disclosure, drawings that need to be used in the description of the embodiments will be briefly introduced below. The drawings in the following description only relate to some embodiments of the present disclosure. For those skilled in the art, other drawings can also be obtained according to these drawings without creative effort.

FIG. 1 is a schematic flowchart of a physical downlink control channel receiving method according to embodiments of the present disclosure.

FIG. 2 is a schematic flowchart of another physical downlink control channel receiving method according to embodiments of the present disclosure.

FIG. 3 is a schematic diagram of distribution of a first resource according to an embodiment of the present disclosure.

FIG. 4 is a schematic flowchart of still another physical downlink control channel receiving method according to embodiments of the present disclosure.

FIG. 5A is a schematic flowchart of still another physical downlink control channel receiving method according to embodiments of the present disclosure.

FIG. 5B is a schematic diagram of a non-interleaved mapping scenario according to an embodiment of the present disclosure.

FIG. 6A is a schematic flowchart of still another physical downlink control channel receiving method according to embodiments of the present disclosure.

FIG. 6B is a schematic diagram of an interleaved mapping scenario according to an embodiment of the present disclosure.

FIG. 7 is a schematic flowchart of still another physical downlink control channel receiving method according to embodiments of the present disclosure.

FIG. 8 is a schematic flowchart of still another physical downlink control channel receiving method according to embodiments of the present disclosure.

FIG. 9 is a schematic flowchart of still another physical downlink control channel receiving method according to embodiments of the present disclosure.

FIG. 10 is a schematic flowchart of still another physical downlink control channel receiving method according to embodiments of the present disclosure.

FIG. 11 is a schematic flowchart of a physical downlink control channel transmitting method according to embodiments of the present disclosure.

FIG. 12 is a schematic flowchart of another physical downlink control channel transmitting method according to embodiments of the present disclosure.

FIG. 13 is a schematic flowchart of still another physical downlink control channel transmitting method according to embodiments of the present disclosure.

FIG. 14 is a schematic flowchart of still another physical downlink control channel transmitting method according to embodiments of the present disclosure.

FIG. 15 is a schematic flowchart of still another physical downlink control channel transmitting method according to embodiments of the present disclosure.

FIG. 16 is a schematic flowchart of still another physical downlink control channel transmitting method according to embodiments of the present disclosure.

FIG. 17 is a schematic flowchart of still another physical downlink control channel transmitting method according to embodiments of the present disclosure.

FIG. 18 is a schematic block diagram of a physical downlink control channel receiving apparatus according to embodiments of the present disclosure.

FIG. 19 is a schematic block diagram of a physical downlink control channel transmitting apparatus according to embodiments of the present disclosure.

FIG. 20 is a schematic block diagram of a device for physical downlink control channel transmission according to embodiments of the present disclosure.

FIG. 21 is a schematic block diagram of a device for physical downlink control channel receiving according to embodiments of the present disclosure.

### DETAILED DESCRIPTION

The technical solutions in the embodiments of the present disclosure are clearly described below with reference to the accompanying drawings in the embodiments of the present disclosure. The embodiments described are merely some embodiments of the present disclosure, and not all embodiments. Other embodiments achieved by those skilled in the art according to the embodiments in the present disclosure without paying creative work shall all fall within the scope of protection of the present disclosure.

The term used in the embodiments of the present disclosure is for the purpose of describing particular examples only and is not intended to limit the embodiments of the present disclosure. As used in embodiments of the present disclosure and the appended claims, the singular forms “a”, “an” and “the” are intended to include the plural forms as well, unless the context clearly indicates otherwise. It should further be understood that the term “and/or” as used herein refers to and includes any and all possible combinations of one or more of the items listed in the associated list.

It shall be understood that, although the terms “first,” “second,” “third,” and the like may be used herein to describe various information, the information should not be limited by these terms. These terms are only used to distinguish the same type of information from each other. For example, without departing from the scope of the present disclosure, first information may be referred as second information; and similarly, second information may also be referred as first information. Depending on the context, the word “if” as used herein can be interpreted as “at the time of”, “when” or “in response to determining”.

For the purpose of simplicity and ease of understanding, the terms used in the present disclosure to represent comparison are “greater than”, “less than”, “higher than” or “lower than”. But for those skilled in the art, it can be understood that the term “greater than” also encompasses the meaning of “greater than or equal to”, “less than” also encompasses the meaning of “less than or equal to”, “higher than” encompasses the meaning of “higher than or equal to”, and “lower than” also encompasses the meaning of “lower than or equal to”.

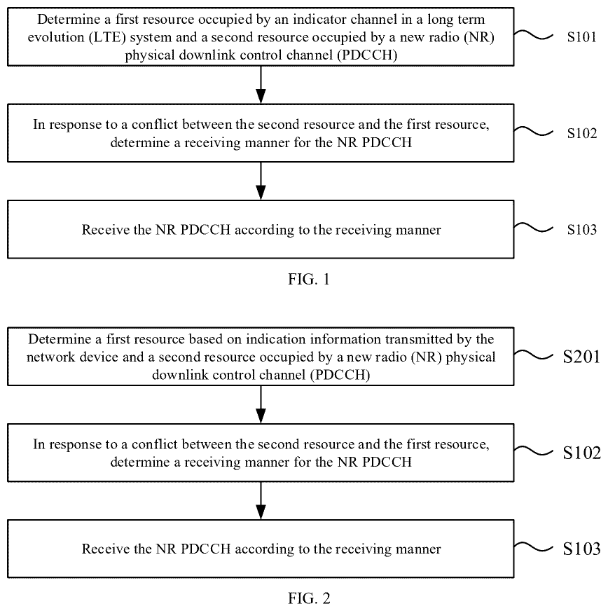

FIG. 1 is a schematic flowchart of a physical downlink control channel receiving method according to embodiments of the present disclosure. The physical downlink control channel receiving method shown in the embodiment can be performed by a terminal. The terminal includes but not limited to a mobile phone, a tablet, a wearable device, a sensor, an IoT device (such as Narrow Band Internet of Thing, abbreviated as NB IoT, Machine Type Communication, abbreviated as MTC, or Enhanced Machine Type Communication, abbreviated as eMTC), or other communication devices. The terminal can communicate with a network device. The network device includes but not limited to a network device (such as a base station, a core network, etc.) in a communication system such as a 4G communication system, a 5G communication system, or a 6G communication system, etc.

As shown in FIG. 1, the physical downlink control channel receiving method may include the following steps S101 to S103.

In step S101, a first resource occupied by an indicator channel in a long term evolution (LTE) system and a second resource occupied by a new radio (NR) physical downlink control channel (PDCCH) are determined.

In step S102, in response to a conflict between the second resource and the first resource, a receiving manner for the NR PDCCH is determined.

In step S103, the NR PDCCH is received according to the receiving manner.

Where the receiving manner includes at least one of:
a first receiving manner: receiving based on puncturing of the NR PDCCH by a network device according to the first resource; or
a second receiving manner: receiving based on rate matching of the NR PDCCH by a network device according to the first resource.

Two possible receiving manners are listed in the embodiments of the present disclosure to receive the NR PDCCH. These two receiving manners do not necessarily have to be used simultaneously, i.e., only one of the above receiving manners can be supported in a communication network system, or both of the above receiving manners can be supported simultaneously, or one of the above receiving manners and another receiving manner not listed in the embodiments of the present disclosure can be supported.

For example, it can be coexistence of the two aforementioned receiving manners, where the terminal can determine which of the two receiving manners to use for receiving based on communication protocol or base station indication. Alternatively, in the embodiments of the present disclosure, there may be only one receiving manner, and the terminal can directly use this receiving manner for receiving. Alternatively, in the embodiments of the present disclosure, in a communication system, there may be a scenario where one of the two receiving manners mentioned above coexists with another receiving manner not listed in the embodiments of the present disclosure. This scenario should also be considered within the protection scope of the embodiments of the present disclosure.

In an embodiment, in response to a conflict between the second resource and the first resource, the terminal may use the first receiving manner to receive the NR PDCCH, that is, the terminal can determine that the network device punctures the NR PDCCH based on the first resource, and a corresponding resource element (RE) is used to transmit the LTE indicator channel. In an embodiment in the present disclosure, the LTE indicator channel may include, but is not limited to, PCFICH and/or PHICH.

For an NR network device, the mapping relationship between NR PDCCH and resources can remain unchanged (when there is not any conflict between the first resource and the second resource), but the NR PDCCH needs to be punctured on an RE corresponding to the first resource, such that NR PDCCH will not be transmitted on the RE corresponding to the first resource.

In response to the network device using a first transmitting manner (puncturing the NR PDCCH based on the first resource) to transmit the PDCCH, the terminal may not consider the existence of the LTE indicator channel when receiving the NR PDCCH, and can receive the NR PDCCH on the RE where the first resource overlaps the second resource, and detect the NR PDCCH based on this. Alternatively, when receiving NR PDCCH, the terminal can consider the existence of the LTE indicator channel, so as not to receive NR PDCCH on the RE where the first resource overlaps the second resource, and only receive NR PDCCH on an RE where the first resource does not overlap the second resource.

The first receiving manner can alleviate the interference caused by the LTE indicator channel on receiving of the NR PDCCH by the terminal, which is beneficial for improving the system capacity for the NR PDCCH and enhancing the performance of NR system. Further, this manner has a relatively simple processing procedure and is easy to implement. However, due to the need to perform puncturing in an overlapping part of the RE corresponding to the NR PDCCH and the RE corresponding to the LTE indicator channel, which may result in the loss of the NR PDCCH.

In an embodiment, in response to a conflict between the second resource and the first resource, if the terminal determines to use the second receiving manner to receive the NR PDCCH, it can be determined that the network device performs rate matching on the NR PDCCH based on the first resource.

For an NR network device, rate matching for the NR PDCCH based on the first resource can map the NR PDCCH to an RE that is not occupied by the LTE indicator channel, thereby changing the mapping relationship between the NR PDCCH and resources (relative to when the first resource and the second resource do not conflict).

In response to the network device using the second transmitting manner (rate matching for the NR PDCCH based on the first resource) to transmit the PDCCH, the terminal can consider the existence of the LTE indicator channel when receiving the NR PDCCH. Since the network device maps the NR PDCCH to the RE without the LTE indicator channel, correspondingly, the terminal detects and receives the NR PDCCH on the RE without transmitting the LTE indicator channel. In an embodiment in the present disclosure, the LTE indicator channel may include, but is not limited to, PCFICH and/or PHICH.

The second receiving manner can alleviate the interference caused by the LTE indicator channel on receiving of the NR PDCCH by the terminal, which is beneficial for improving the system capacity for the NR PDCCH and enhancing the performance of NR system. This manner can ensure the integrity of the NR PDCCH to the greatest extent possible.

According to the embodiments of the present disclosure, in response to a conflict between the first resource occupied by the LTE indicator channel and the second resource occupied by the NR PDCCH, the NR PDCCH is received through either the first receiving manner or the second receiving manner, which can alleviate the problems caused by the conflict between the first resource and the second resource, which is beneficial for improving the system capacity for the NR PDCCH and enhancing the performance of the NR system.

However, it should be noted that the receiving manner is not limited to the first receiving manner or the second receiving manner mentioned above. Other receiving methods can be selected as needed, and other receiving methods can also alleviate the problems caused by the conflict between the first resource and the second resource.

In an embodiment, the indicator channel includes at least one of:
Physical Control Format Indicator Channel (PCFICH); or
Physical Hybrid ARQ Indicator Channel (PHICH).

Where the PCFICH can carry a Control Field Indicator (CFI), which is used to indicate the number of Orthogonal Frequency Division Multiplexing (OFDM) symbols occupied by a control channel (such as the PDCCH, or the PHICH, etc.) in a subframe. For example, an CFI can carry 2 bits of information and be modulated through Quadrature Phase Shift Keying (QPSK).

The PHICH can carry Hybrid Automatic Repeat reQuest (HARQ) information, such as HARQ-ACK or HARQ-NACK. The network device can indicate to the terminal through PHICH whether the uplink information has been successfully received, and the terminal determines whether to retransmit the uplink information based on the indication in PHICH.

It should be noted that the embodiments of the present disclosure can be applied not only to situations where the first resource occupied by the LTE indicator channel conflicts with the second resource occupied by the NR PDCCH, but also to situations where the first resource occupied by the LTE CRS (Cell-specific Reference Signal) conflicts with the second resource occupied by the NR PDCCH. That is, the method can include steps S101a, S102a, and S103a.

In step S101a, a first resource occupied by the Cell-specific Reference Signal (CRS) in a long term evolution (LTE) system and a second resource occupied by a new radio (NR) physical downlink control channel (PDCCH) are determined.

In step S102a, in response to a conflict between the second resource and the first resource, a receiving manner for the NR PDCCH is determined.

In step S103a, the NR PDCCH is received according to the receiving manner.

Where the receiving manner includes at least one of:
a first manner: the NR PDCCH is punctured based on the first resource; or
a second manner: rate matching (RM) is performed on the NR PDCCH based on the first resource.

Where the same explanations and limitations in the above two implementation manners will not be repeated.

FIG. 2 is a schematic flowchart of another physical downlink control channel receiving method according to embodiments of the present disclosure. As shown in FIG. 2, the determination of the first resource occupied by the indicator channel in the Long Term Evolution (LTE) system includes step S201.

In step S201, the first resource is determined based on indication information transmitted by the network device.

In an embodiment, the indication information may be broadcast information or unicast information. Where the broadcast information can include system information, paging information, etc., and the unicast information can include Radio Resource Control (RRC) signaling, Downlink control information (DCI), Media Access Control Element (MAC CE), etc. Where the first resource can be the first resource occupied by the indicator channel in the LTE system or the first resource occupied by the CRS in the LTE system.

The following mainly provides an exemplary explanation of the embodiments in the present disclosure when the indication information is RRC signaling.

In an embodiment, when the resource occupied by PCFICH is indicated through the RRC signaling, it can be indicated through any field or information element (IE) in the RRC signaling. In an embodiment in the present disclosure, the information element RateMatchPattenLTE-PCFICH in the RRC signaling can be used for indication, or existing elements in the RRC signaling can be reused. RateMatchPattenLTE-PCFICH can include some or all of the following Information Elements (IEs):

| RateMatchPattenLTE-PCFICH: : = | SEQUENCE{ | |
|---|---|---|
| Uplink-downlink configuration | {0,...,6}, | OPTIONAL, -- Need M |
| Special subframe configuration | {0,...,10}, | OPTIONAL, -- Need M |
| srs-UpPtsAdd | {0,2,4}, | OPTIONAL, -- Need M |

| | |
|---|---|
| PCI | ENUMERATED{0,...,83}, |

}

Where the Uplink-downlink configuration is used to indicate the downlink/uplink subframe configuration in Table 4.2-2 of the 3GPP 36.211 Technical Specification, and can also be named subframe assignment.

The Special subframe configuration is used to indicate the configuration index in List 4.2-1 of the 3GPP 36.211 Technical Specification.

The srs-UpPtsAdd is used to indicate the duration of the Uplink Pilot Time Slot (UpPTS) in the 3GPP 36.211 Technical Specification.

PCI (Physical Cell ID) is used to indicate the physical cell index and has a certain correspondence with the physical cell index.

In Need M, M represents Maintain, and Need M represents that when the corresponding domain does not exist, it needs to be stored by the user equipment (UE).

It should be noted that the IE included in RateMatchPattenLTE-PCFICH is not limited to the above-mentioned IEs. In some embodiments, other IEs can also be included. For example, when RateMatchPattenLTE-CRS is not configured with mbsfn-SubframeConfigList, RateMatchPattenLTE-PCFICH can include mbsfn-SubframeConfigList. It should be noted that RateMatchPattenLTE-PCFICH can include one or more of the IEs mentioned above, as well as other IEs.

In an embodiment, when the resources occupied by the PHICH is indicated through RRC signaling, the information element RateMatchPattenLTE-PHICH in RRC signaling can be defined for indication. RateMatchPattenLTE-PHICH may include some or all of the following information elements (IEs):

| | |
|---|---|
| RateMatchPattenLTE-PHICH: : = | SEQUENCE{ |
| PHICH duration | {normal , extend} |
| phich-Resource | ENUMERATED{oneSixth , half , one , two}, |

}

Where Phich duration is used to indicate the duration of PHICH, for example, refer to Table 6.9.3-1 of 3GPP 36.211 Technical Specification.

phich-Resource, the parameter

$${N}_{g} ∈ \{ \frac{1}{6} , \frac{1}{2} , 1 , 2 \} ,$$

is related to the number of configured PHICH groups and can be referred to in clause 6.9 of the 3GPP 36.211 Technical Specification. Where the value corresponding to oneSixth is ⅙, the value corresponding to half is ½, and so on.

It should be noted that RateMatchPattenLTE-PHICH is not limited to including the two IEs mentioned above, but it can also include other IEs.

When RateMatchPattenLTE-PCIFCH includes IEs such as Uplink-downlink configuration, Special subframe configuration, and srs-UpPtsAdd, RateMatchPattenLTE-PHICH can only include two IEs: PHICH duration and phich-Resource; When RateMatchPattenLTE-PCIFCH does not include IEs such as Uplink-downlink configuration, Special subframe configuration, and srs-UpPtsAdd mentioned above, RateMatchPattenLTE-PHICH can also include IEs such as Uplink-downlink configuration, Special subframe configuration, and srs-UpPtsAdd.

Where the network device can indicate LTE CRS to the terminal.

In an embodiment, the network device can indicate not only the first resources occupied by PCFICH or PHICH, but also the resource occupied by LTE CRS.

For example, when the resource occupied by LTE CRS is indicated through RRC signaling, it can be indicated through any field or information element IE in the RRC signaling. In an embodiment in the present disclosure, RateMatchPattenLTE-CRS in RRC signaling can be used for indication. The RateMatchPattenLTE-CRS may include some or all of the following IEs:

| | |
|---|---|
| RateMatchPattenLTE-CRS: := | SEQUENCE{ |
| carrierFreqDL | INTEGER(0...16383) |
| carrierBandwidthDL | NUMERATED{ n6 , n15 , n25 , n50 , n75 , n100 , |

spare2 , spare1}

| | |
|---|---|
| mbsfn-SubframeConfigList | EUTRA-MBSFN-SubframeConfigList |

OPTINAL, --Need M

| | |
|---|---|
| nrofCRS-Ports | NUMERATED{ n1 , n2 , n4 } |
| v_Shift | NUMERATED{ n0 , n1 , n2 , n3 , n4 , n5 } |

}

Where carrierFreqDL represents the number of subcarrier offsets between the LTE carrier center and the reference point (e.g., point A).

CarrierBandwidthDL represents the configured LTE carrier bandwidth.

The mbsfn-SubframeConfigList represents the subframe configuration of the Multicast Broadcast Single Frequency Network (MBSFN).

nrofCRS-Ports represents the number (e.g., 1, 2, or 4) of antenna ports corresponding to LTE CRS.

ν-Shift represents LTE CRS frequency domain subcarrier offset ν_{shift}.

The following embodiments are mainly illustrated in the case where the first resource occupied by the LTE indicator channel conflicts with the second resource occupied by the NR PDCCH.

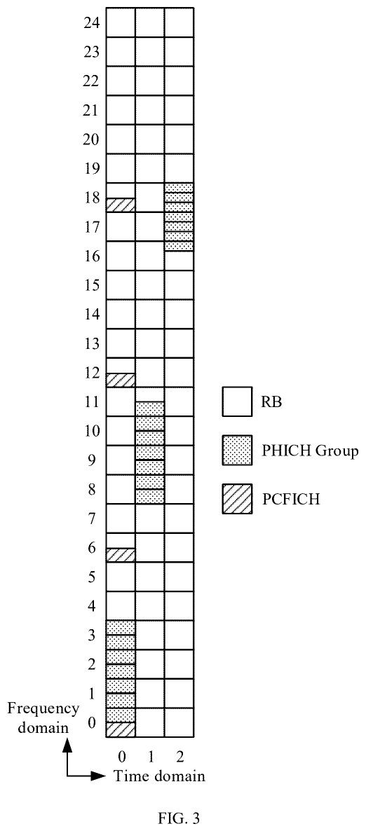

FIG. 3 is a schematic diagram of distribution of a first resource according to an embodiment of the present disclosure.

PCFICH can be distributed on the first symbol within an LTE time slot, and PHICH can be distributed on one or more symbols within an LTE time slot.

FIG. 3 shows the resource distribution diagram of PCFICH and PHICH in the scenario of time division duplex, with PHICH duration configured as extend, parameter Ng=2, the number of configured LTE CRS ports is 4, the number

$${N}_{RB}^{DL}$$

of downlink RBs is 25, and physical cell identifier

$${N}_{ID}^{cell} = 0 .$$

Where

$${N}_{ID}^{cell}$$

can be determined jointly based on PCI and v-Shift in the IEs mentioned above:

$${N}_{ID}^{cell} = 6 * PCI + v\_shift .$$

In the scenario shown in FIG. 3, on the first three time-domain symbols within an LTE time slot, PCFICH is distributed on the first symbol, and PHICH is distributed on the first three symbols. PHICH includes multiple groups, namely PHICH Group 0, PHICH Group1, PHICH Group 2, PHICH Group 3, PHICH Group 4, PHICH Group 5, and PHICH Group 6.

PCFICH is distributed on the first symbol within an LTE time slot. In the scenario shown in FIG. 3, PCFICH is distributed on RB #0, RB #6, RB #12, and RB #18. The 7 groups corresponding to PHICH are distributed on three symbols, corresponding to RB #0 to RB #3 corresponding to the first symbol, RB #8 to RB #11 corresponding to the second symbol, and RB #16 to RB #18 corresponding to the third symbol.

It should be noted that due to the existence of LTE CRS, LTE CRS also occupies some REs in some RBs, and the REs occupied by PCFICH and PHICH do not overlap the REs occupied by LTE CRS.

In the scenario shown in FIG. 3, LTE CRS exists on the first and second symbols, and one RB corresponds to 12 REs in the frequency domain. LTE CRS exists on the 1st, 4th, 7th, and 10th REs in each RB.

In the scenario shown in FIG. 3, PCFICH occupies 4 REs in one REG in the frequency domain, and each PHICH Group also occupies 4 REs in one REG in the frequency domain. Therefore, in the first symbol or the second symbol, PCFICH and LTE CRS occupy 6 REs (where 2 REs are occupied by LTE CRS) in an RB, and a PHICH Group and LTE CRS occupy 6 REs (where 2 REs are occupied by LTE CRS) in an RB. In the third symbol, in the scenario of the absence of LTE CRS, each PHICH Group occupies 4 REs.

It should be noted that indicator channels such as PCFICH and PHICH in LTE systems can be transmitted by the LTE network device, but the NR network device can also determine the resource occupied by the indicator channel, such as through communication with the LTE network device or based on protocol agreements. In addition, the terminal can also determine the resources occupied by the indicator channel. For example, the terminal can determine the resources occupied by the indicator channel based on a predefined rule, or determine the resources occupied by the indicator channel based on indication from the NR network device.

Due to the existence of indicator channels such as PCFICH and PHICH, when the RE occupied by the indicator channel overlaps the RE occupied by the NR PDCCH, there is a conflict between the first resource occupied by the indicator channel and the second resource occupied by the NR PDCCH, thereby causing interference to the terminal in receiving the NR PDCCH.

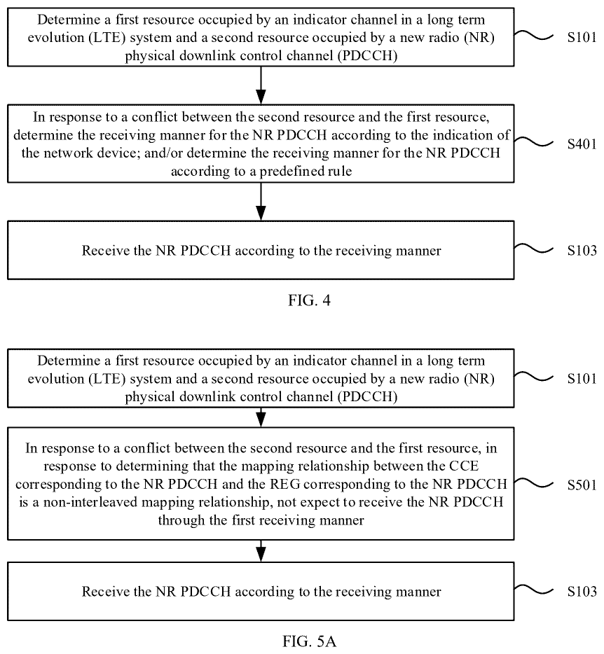

FIG. 4 is a schematic flowchart of still another physical downlink control channel receiving method according to embodiments of the present disclosure. As shown in FIG. 4, determining the receiving manner for the NR PDCCH includes:

In step S401, the receiving manner for the NR PDCCH is determined according to the indication from the network device; and/or the receiving manner for the NR PDCCH is determined according to a predefined rule.

In an embodiment, the network device may transmit an indication (such as RRC signaling, DCI, MAC CE, etc.) to the terminal such that the terminal can determine whether to receive the NR PDCCH through the first receiving manner or the second receiving manner based on the indication from the network device.

The terminal can also determine whether to receive the NR PDCCH through the first receiving manner or through the second receiving manner based on the predefined rule, such as protocol agreements.

The following embodiments illustrate how the terminal determines the receiving manner for the NR PDCCH based on the predefined rule. The description of the first receiving manner and the second receiving manner can refer to other embodiments in the present disclosure and will not be repeated here.

FIG. 5A is a schematic flowchart of still another physical downlink control channel receiving method according to embodiments of the present disclosure. As shown in FIG. 5A, determining the receiving manner for the NR PDCCH according to the predefined rule includes:

In step S501, in response to the mapping relationship between the Control Channel Element (CCE) corresponding to the NR PDCCH and the Resource Element Group (REG) corresponding to the NR PDCCH (i,e., the CCE-to-REG mapping relationship) being a non-interleaved mapping relationship, it is not expected to receive the NR PDCCH through the first receiving manner (which can also be described as expected to receive the NR PDCCH through the second receiving manner).

The resources occupied by NR PDCCH transmission are composed of CCEs. The number of CCEs that make up NR PDCCH transmission resources can be referred to as Aggregation Level (AL).

In an embodiment, when the mapping relationship between the CCE and REG corresponding to the NR PDCCH is a non-interleaved mapping relationship, the REGs that make up the NR PDCCH are continuous in the time-frequency domain.

Every L number of REGs form a REG bundle, and one or more REG bundles can form a CCE. However, a CCE consists of 6 REGs, and a REG bundle can be distributed over M symbols in a manner of time domain first and then frequency domain. Where the distribution in the manner of time domain first and then frequency domain refers to distributing (such as uniformly distributing) the REG bundle on multiple RBs included in one or more time domain symbols corresponding to one RB index, where the number of time domain symbols is equal to the number of CORESET persistent symbols. If the number of REGs is greater than the number of time domain symbols, the REGs continue to be distributed on multiple RBs included in one or more time domain symbols corresponding to the next RB index (for example, in the direction of increasing frequency domain corresponding to RB), and so on, until one REG bundle equals L number of REGs.

FIG. 5B is a schematic diagram of a non-interleaved mapping scenario according to an embodiment of the present disclosure.

In the case where the mapping relationship between CCE and REG corresponding to NR PDCCH is non-interleaved mapping relationship, L=6, and M=1, 2 or 3. As shown in FIG. 5B, in the case of M=2, REGs are distributed on the first and second symbols, and every 6 REGs form a REG bundle. For example, REG #0 to REG #5 form REG bundle #0, REG #6 to REG #11 form REG bundle #1, and the CCE fixedly includes 6 REGs. Therefore, in this case, an REG bundle is exactly the same as a CCE. As shown in FIG. 5A, the REGs that make up the NR PDCCH are continuous.

According to FIG. 3, it can be seen that the resources occupied by the indicator channel are also largely continuous. If the first receiving manner is used to receive the NR PDCCH and the second resource occupied by the NR PDCCH is punctured based on the first resource, it will result in puncturing the NR PDCCH within the continuous resource range, causing a large amount of missing information in the DCI carried by the NR PDCCH, which has a relatively serious impact on the transmission performance of the PDCCH.

Therefore, according to this embodiment, the predefined rule can stipulate that when the mapping relationship between the CCE and REG corresponding to NR PDCCH is a non-interleaved mapping relationship, the terminal does not expect to receive NR PDCCH through the first receiving manner. So when the terminal determines that the mapping relationship between the CCE and REG corresponding to the NR PDCCH is a non-interleaved mapping relationship, it does not expect to receive the NR PDCCH through the first receiving manner (puncturing), and instead to receive the NR PDCCH through the second receiving manner (rate matching), so as to avoid causing a large amount of missing information in the DCI carried by the NR PDCCH, which seriously affects the transmission performance of the PDCCH. Correspondingly, the NR network device that transmits NR PDCCH can relatively easily avoid the RE corresponding to the first resource through rate matching, thereby ensuring the transmission performance of PDCCH.

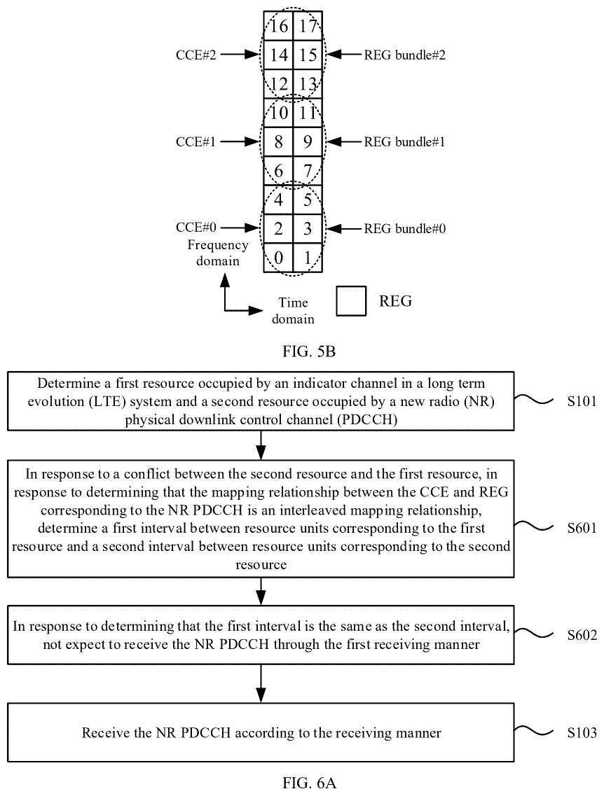

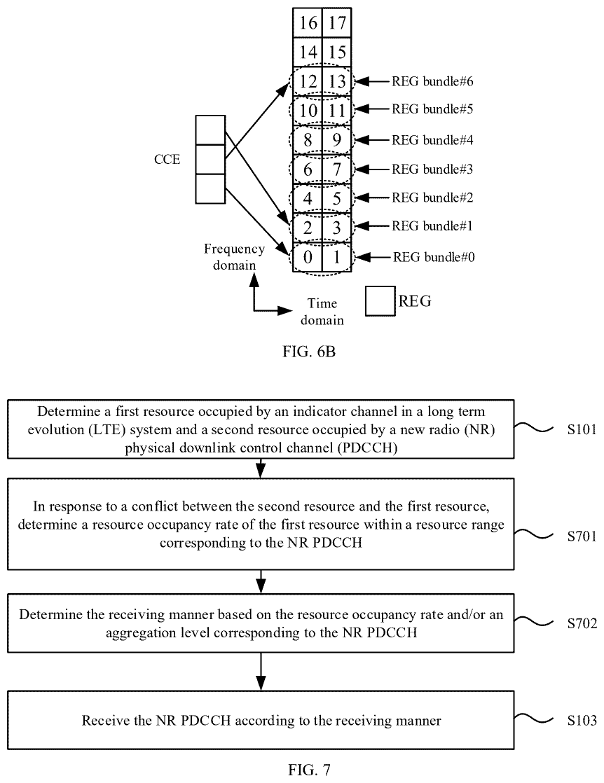

FIG. 6A is a schematic flowchart of still another physical downlink control channel receiving method according to embodiments of the present disclosure. As shown in FIG. 6A, determining the receiving manner for the NR PDCCH according to the predefined rule includes steps S601 and S602.

In step S601, in response to the mapping relationship between the CCE and REG corresponding to the NR PDCCH being an interleaved mapping relationship, a first interval between resource units corresponding to the first resource and a second interval between resource units corresponding to the second resource are determined.

In step S602, in response to the first interval being the same as the second interval, it is not expected to receive the NR PDCCH through the first receiving manner (which can also be described as expected to receive the NR PDCCH through the second receiving manner). For example, the first interval can be measured based on the number of RBs or REGs, and when the number is greater than 1, it is not expected to receive the NR PDCCH through the first receiving manner when the first interval is the same as the second interval.

In an embodiment, when the mapping relationship between the CCE and the REG corresponding to the NR PDCCH is an interleaved mapping relationship, as shown in FIG. 6B below, the REGs that make up the NR PDCCH may be discontinuous in some cases.

Every L number of REGs form a REG bundle, and one or more REG bundles can form a CCE. However, a CCE consists of 6 REGs, and REGs can be distributed over M symbols in a manner of time domain first and then frequency domain.

FIG. 6B is a schematic diagram of an interleaved mapping scenario according to an embodiment of the present disclosure.

In the case where the mapping relationship between CCE and REG corresponding to NR PDCCH is an interleaved mapping relationship, when M=1, L=2 or 6, and when M=2 or 3, L=M or 6. The correspondence between a CCE and an REG bundle requires interleaving through an interleaver, which allows continuous REG bundles in CCE to have an interval in the frequency domain, where the interval can be determined based on the frequency domain span parameter C, where

$$C = {N}_{REG}^{CORESET} / LR .$$

If the interval is determined by the number of REG bundles in the frequency domain, the interval is equal to C. If the interval is determined by the number of REGs in the frequency domain, then the interval is equal to C*n, where n is equal to the number of REGs that a REG bundle lasts for on an OFDM symbol.

$${N}_{REG}^{CORESET}$$

is the number of REG bundles in the control resource set (CORESET) corresponding to NR PDCCH, and R is the number of interleaving rows.

As shown in FIG. 6B, in the case of M=2, REGs are distributed on the first and second symbols, with every two REGs forming a REG bundle. For example, REG #0 and REG #1 form REG bundle #0, REG #2 and REG #3 form REG bundle #1, REG #4 and REG #5 form REG bundle #2, REG #6 and REG #7 form REG bundle #3, REG #8 and REG #9 form REG bundle #4, REG #10 and REG #11 form REG bundle #5, and REG #12 and REG #13 form REG bundle #6.

For example, when

$${N}_{REG}^{CORESET} = 24 ,$$

L=2, and R=2, C=6 can be calculated through

$$C = {N}_{REG}^{CORESET} / LR .$$

Since a CCE fixedly includes 6 REGs, in this case, one CCE includes three REG bundles, and one REG bundle occupies 2 REGs. In the CCE, the first REG bundle is separated from the second REG bundle by 6 REGs. For example, in CCE #0, the three REG bundles correspond to REG bundle #0, REG bundle #6, and REG bundle #1 in sequence. There is an interval between the REG bundles, which makes the REGs that make up the NR PDCCH discontinuous.

According to FIG. 3, it can be seen that the resources occupied by the indicator channel are largely continuous, but there are also discontinuous parts. If the first interval (for example, the first interval between resource units corresponding to PCFICH in FIG. 3 is 6 REGs) between resource units in the first resource occupied by the LTE indicator channel is exactly the same as the second interval (under the parameter configuration, the second interval is also 6 REGs) between resource units in the second resource occupied by the NR PDCCH, the first receiving manner is adopted to receive the NR PDCCH and puncturing the second resource occupied by the NR PDCCH based on the first resource may result in puncturing an entire PDCCH on the corresponding resource, which may result in a large amount of missing information in the DCI carried by the NR PDCCH, and have a relatively serious impact on the transmission performance of the PDCCH.

Therefore, according to this embodiment, the first interval between resource units corresponding to the first resource and the second interval between resource units corresponding to the second resource can be determined, where the resource units can be physical resource blocks (PRBs), REGs, REG bundles, etc., to determine whether the first interval and the second interval are the same.

In the case where the first interval is the same as the second interval, if the first receiving manner is used to receive the NR PDCCH and the second resource occupied by the NR PDCCH is punctured based on the first resource, it will result in puncturing the NR PDCCH within the continuous resource range, causing a large amount of missing information in the DCI carried by the NR PDCCH, which has a relatively serious impact on the transmission performance of the PDCCH.

Therefore, according to this embodiment, the predefined rule can stipulate that in response to the mapping relationship between the CCE and REG corresponding to the NR PDCCH being an interleaved mapping relationship, and the first interval is the same as the second interval, the terminal does not expect to receive the NR PDCCH through the first receiving manner (i.e., the terminal uses other manners to receive the NR PDCCH except the first receiving manner, such as using the second receiving manner or other receiving manners to receive the NR PDCCH). So when the terminal determines that the mapping relationship between the CCE and REG corresponding to the NR PDCCH is an interleaved mapping relationship, and the first interval is the same as the second interval, the terminal does not expect to receive the NR PDCCH through the first receiving manner, and instead receives the NR PDCCH through the second receiving manner, so as to avoid causing a large number of NR PDCCHs to be missing in some resources, which seriously affects the transmission performance of the PDCCH. Correspondingly, the NR network device that transmits NR PDCCH can relatively easily avoid the RE corresponding to the first resource through rate matching, thereby ensuring the transmission performance of PDCCH.

In addition, when the first interval is different from the second interval, the NR PDCCH can be received through either the second receiving manner or the first receiving manner.

FIG. 7 is a schematic flowchart of still another physical downlink control channel receiving method according to embodiments of the present disclosure. As shown in FIG. 7, determining the receiving manner for the NR PDCCH according to the predefined rule includes steps S701 and S702.

In step S701, a resource occupancy rate of the first resource within a resource range corresponding to the NR PDCCH is determined.

In step S702, the receiving manner is determined based on the resource occupancy rate and/or an aggregation level corresponding to the NR PDCCH.

In an embodiment, the resource occupancy rate of the first resource within the resource range corresponding to the NR PDCCH can be determined, where the resource occupancy rate is the ratio of the number of some or all resource units corresponding to the first resource to the number of some or all resource units in the resource range. The resource range is the control resource set (CORESET) where the NR PDCCH is located, or the resource occupied by the bandwidth part (BWP) where the NR PDCCH is located, or the resource occupied by the NR PDCCH.

The resource unit includes but is not limited to an RE, an RB, an REG, or an REG bundle. The resource range can be all or part of the resources in the CORESET where the NR PDCCH is located, or all or part of the resources in the BWP where the NR PDCCH is located, or all or part of the resources (such as those corresponding to the aggregation level) occupied by the NR PDCCH. Part of resources can be resources corresponding to partial frequency domain and/or partial time domain, and part of resource units can be resource units corresponding to partial frequency domain and/or partial time domain.

For example, in the scenario shown in FIG. 3, where the resource range is part of resources in the CORESET where the NR PDCCH is located, the CORESET corresponds to 3 symbols in the time domain. Taking the resource corresponding to the first symbol as an example, the CORESET corresponds to 25 RBs in the frequency domain, and one RB corresponds to 12 REs in the frequency domain.

Considering PCFICH and PHICH, according to FIG. 3, on the first OFDM symbol of the LTE time slot, PCFICH is stored in 4 RBs and occupies 4 REs in each RB. Therefore, the first resource occupied by PCFICH is 4*4=16 REs. The first resource occupied by 7 PHICH groups, each occupying 4 REs, is 4*7=28 REs. So the first resource occupied by the two indicator channels is 42 REs, and it can be determined that the resource occupancy rate in the first OFDM symbol, corresponding to 25 RBs (which can be the RBs corresponding to BWP), is 42/(12*25), which is equal to 14%. That is: Resource occupancy rate=(number of REs occupied by PCFICH+number of REs occupied by PCFICH)+total number of REs.

Considering PCFICH, PHICH, and LTE CRS, for example, based on the embodiment shown in FIG. 3, LTE CRS corresponds to 4 ports and occupies 4 REs in each RB corresponding to the first symbol, and then it can be determined that the first resource occupied by LTE CRS in 25 RBs is 4*25=100 REs. The first resource occupied by the two indicator channels and LTE CRS is 42+100=142 REs. So the resource occupancy rate in the first OFDM symbol, corresponding to 25 RBs, is 142/(12*25), which is equal to 47%. That is: Resource occupancy rate=(number of REs occupied by PCFICH+number of REs occupied by PCFICH+number of REs occupied by LTE CRS)+total number of REs.

Taking the resources corresponding to the three symbols in CORESET as an example,
considering PCFICH and PHICH, according to FIG. 3, on the first OFDM symbol of the LTE time slot, PCFICH is stored in 4 RBs and occupies 4 REs in each RB. Therefore, the first resource occupied by PCFICH is 4*4=16 REs. The first resource occupied by 7 PHICH groups, each occupying 4 REs, is 4*7=28 REs. Similarly, on the second symbol or the third symbol, the first resource occupied by PHICH is also 4*7=28 REs. Therefore, on the three symbols, the first resource occupied by PHICH is 28*3=84 REs. PCFICH occupies 16 REs on the first symbol, and the first resource occupied by the two indicator channels is 100 REs. Therefore, it can be determined that the resource occupancy rate in the three OFDM symbols, each corresponding to the 25 RBs, is 100/(3*12*25), which is approximately equal to 11%. That is: Resource occupancy rate=(number of REs occupied by PCFICH+number of REs occupied by PCFICH)+total number of REs.

Considering PCFICH, PHICH, and LTE CRS, for example, based on the embodiment shown in FIG. 3, LTE CRS corresponds to 4 ports and occupies 4 REs in each RB corresponding to the first symbol, and then it can be determined that the first resource occupied by LTE CRS in 25 RBs is 4*25=100 REs. Similarly, the first resource occupied by LTE CRS in the second symbol is also 100 REs, and there is no LTE CRS in the third symbol. So on the three OFDM symbols, the first resource occupied by the two indicator channels and LTE CRS is 100+2*100=300 REs. So it can be determined that the resource occupancy rate in the three OFDM symbols, each corresponding to 25 RBs, is 300/(3*12*25), which is equal to 33%. That is: Resource occupancy rate=(number of REs occupied by PCFICH+number of REs occupied by PCFICH+number of REs occupied by LTE CRS)+total number of REs.

As the resource occupancy rate increases, there may be more overlap between the first resource and the second resource. Therefore, using the first receiving manner to receive NR PDCCH may result in a large number of NR PDCCHs being missing, seriously affecting the transmission performance of PDCCH. Therefore, the predefined rule can stipulate that the higher the resource occupancy rate, the less expected the terminal is to receive the NR PDCCH through the first receiving manner, that is, the more inclined the terminal is to receive the NR PDCCH through the second receiving manner, which is conducive to avoiding a large number of missing NR PDCCHs and ensuring relatively good transmission performance of the PDCCH.

The NR PDCCH is composed of CCEs, and the number of CCEs that make up the NR PDCCH is called the aggregation level (AL) (for example, it can be a value of 1, 2, 4, 8, or 16, etc.). The higher the aggregation level, the more resources the NR PDCCH occupies. After puncturing the NR PDCCH, a relatively large amount of NR PDCCH content can still be left, so the impact on the NR PDCCH is relatively small. Therefore, the predefined rule can stipulate that the higher the aggregation level, the less expected the terminal is to receive the NR PDCCH through the second receiving manner, that is, the more inclined the terminal is to receive the NR PDCCH through the first receiving manner, so as to simplify the processing process.

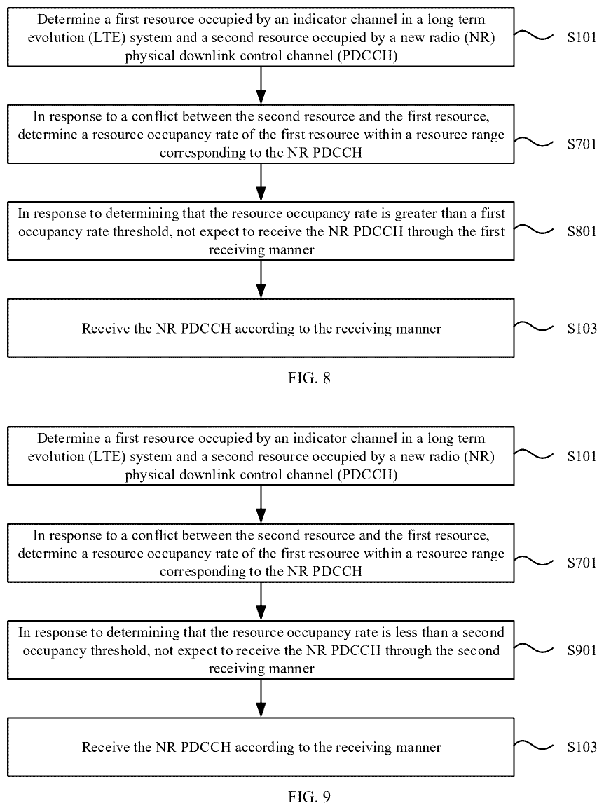

FIG. 8 is a schematic flowchart of still another physical downlink control channel receiving method according to embodiments of the present disclosure. As shown in FIG. 8, determining the receiving manner based on the resource occupancy rate and/or the aggregation level corresponding to the NR PDCCH includes step S801.

In step S801, in response to the resource occupancy rate being greater than a first occupancy rate threshold, it is not expected to receive the NR PDCCH through the first receiving manner.

In an embodiment, as the resource occupancy rate increases, there may be more overlap between the first resource and the second resource. Therefore, using the first method of receiving the NR PDCCH may result in a large number of NR PDCCHs being missing, seriously affecting the transmission performance of PDCCH.

Therefore, the predefined rule can stipulate that when the resource occupancy rate exceeds the first occupancy rate threshold (which can be set as needed, such as 50%), the terminal does not expect to receive the NR PDCCH through the first receiving manner, that is, the terminal expects to receive the NR PDCCH through the second receiving manner, which is conducive to avoiding a large number of missing of the NR PDCCH and ensuring relatively good transmission performance of the PDCCH.

FIG. 9 is a schematic flowchart of still another physical downlink control channel receiving method according to embodiments of the present disclosure. As shown in FIG. 9, determining the receiving manner based on the resource occupancy rate and/or the aggregation level corresponding to the NR PDCCH includes step S901.

In step S901, in response to the resource occupancy rate being less than a second occupancy threshold, it is not expected to receive the NR PDCCH through the second receiving manner.

In an embodiment, the lower the resource occupancy rate, the lower the overlap between the first resource and the second resource may be. Therefore, using the first receiving manner to receive NR PDCCH will not result in a large number of missing for the NR PDCCH, and seriously affect the transmission performance of PDCCH.

Therefore, the predefined rule can stipulate that when the resource occupancy rate is less than the second occupancy rate threshold (which can be set as needed, such as 10%), the terminal does not expect to receive the NR PDCCH through the second receiving manner, that is, the terminal expects to receive the NR PDCCH through the first receiving manner, so as to simplify the processing.

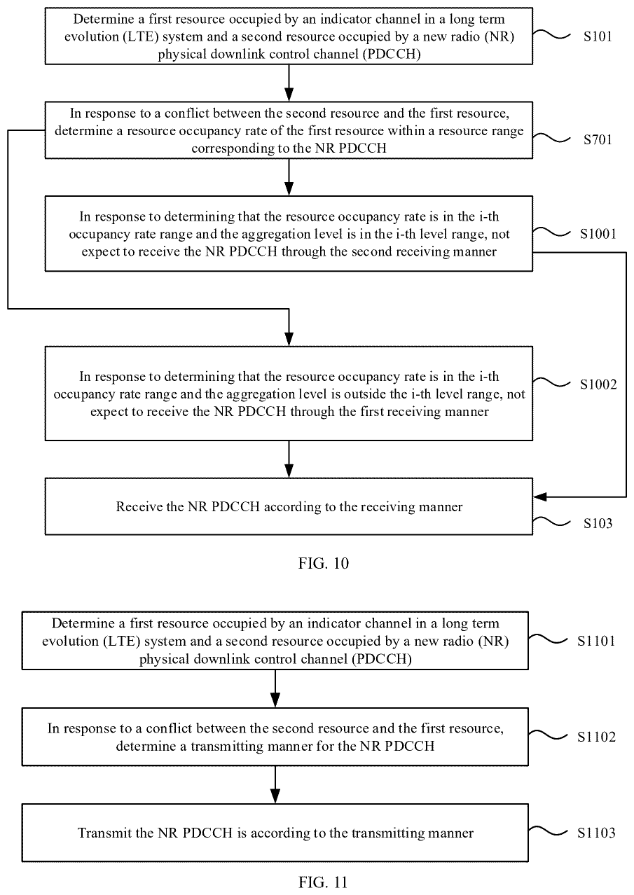

FIG. 10 is a schematic flowchart of still another physical downlink control channel receiving method according to embodiments of the present disclosure. As shown in FIG. 10, determining the receiving manner based on the resource occupancy rate and/or the aggregation level corresponding to the NR PDCCH includes step S1001 and S1002.

In step S1001, in response to the resource occupancy rate being in the i-th occupancy rate range and the aggregation level is in the i-th level range, it is not expected to receive the NR PDCCH through the second receiving manner (also described as it is expected to receive the NR PDCCH through the first receiving manner).

In step S1002, in response to the resource occupancy rate being in the i-th occupancy rate range and the aggregation level is outside the i-th level range, it is not expected to receive the NR PDCCH through the first receiving manner (also described as it is expected to receive the NR PDCCH through the second receiving manner).

Where an upper limit of the i-th occupancy rate range is less than or equal to a lower limit of an (i+1)-th occupancy rate range, and a lower limit of the i-th level range is less than or equal to a lower limit of an (i+1)-th level range.

In the embodiments of the present disclosure, the i-th occupancy rate range can be indicated by the base station or determined by the communication protocol. The correspondence between the aggregation level and the level range can be indicated by the base station or determined by the communication protocol. In an embodiment, the correspondence between the aggregation level and the level range can also be determined by the network side device, that is, the network side device determines a corresponding aggregation level based on the current resource occupancy rate being in the i-th occupancy rate range.

The embodiment shown in FIG. 10 may be executed when the resource occupancy rate is less than or equal to the first occupancy rate threshold and greater than or equal to the second occupancy rate threshold.

In an embodiment, on the one hand, the higher the resource occupancy rate, the more overlapping parts of the first resource and the second resource may be. On the other hand, the higher the aggregation level, the higher the degree of discontinuity of the second resource corresponding to NR PDCCH, and the less overlap the second resource may have with the first resource.

It can be seen that the amount of overlap between the first resource and the second resource is influenced by both the resource occupancy rate and aggregation level. Therefore, the predefined rule can be defined from these two aspects.

For example, n occupancy intervals and n level ranges can be constructed first, where an upper limit of the i-th occupancy rate range is less than or equal to a lower limit of an (i+1)-th occupancy rate range, and a lower limit of the i-th level range is less than or equal to a lower limit of an (i+1)-th level range. Where i and n are positive integers, and i is less than or equal to n.

Furthermore, through the pre-defined rule, in response to the resource occupancy rate being in an i-th occupancy rate range and the aggregation level is in an i-th level range, it is not expected to receive the NR PDCCH through the second receiving manner.

And in response to the resource occupancy rate being within the i-th occupancy rate range and the aggregation level is outside the i-th level range, it is not expected to receive the NR PDCCH through the first receiving manner.

When the resource occupancy rate is in a high range and the aggregation level is also in a high range, the aggregation level causes the NR PDCCH to occupy relatively more resources. Although the LTE indicator channel occupies more resources, puncturing the NR PDCCH can still leave relatively more NR PDCCH content, so the impact on the NR PDCCH is relatively small. Therefore, the first method of receiving the NR PDCCH can be used to simplify the processing process.

When the resource occupancy rate is in a high range but the aggregation level is in a low range, the aggregation level causes the NR PDCCH to occupy relatively less resources, and the LTE indicator channel occupies more resources. After puncturing the NR PDCCH, there will be relatively less NR PDCCH content left, which has a significant impact on the NR PDCCH. Therefore, the second receiving manner can be used to receive the NR PDCCH, which is conducive to avoiding a large number of missing of the NR PDCCH and ensuring relatively good transmission performance of the PDCCH.

When the resource occupancy rate is in a low range and the aggregation level is in a high range, the aggregation level causes the NR PDCCH to occupy relatively more resources, and the LTE indicator channel occupies relatively less resources. Therefore, after puncturing the NR PDCCH, there is still relatively more NR PDCCH content left, so the impact on the NR PDCCH is relatively small. Therefore, the first method of receiving the NR PDCCH can be used to simplify the processing.

When the resource occupancy rate is in a low range, but the aggregation level is also in a low range, the aggregation level makes the NR PDCCH occupy relatively less resources. Although the LTE indicator channel occupies less resources, puncturing the NR PDCCH may still leave relatively less NR PDCCH content, which has a significant impact on the NR PDCCH. Therefore, the second receiving manner can be used to receive the NR PDCCH, which is conducive to avoiding a large number of missing of the NR PDCCH and ensuring relatively good transmission performance of the PDCCH.

In an embodiment, the relationship between the resource occupancy rate, aggregation level, and receiving manner specified by the predefined rule can be shown in Table 1:

TABLE 1

| Resource | | |
|---|---|---|
| occupancy rate | Aggregation level | Receiving manner |
| <10% | 1, 2, 4, 8, 16 | First receiving manner |
| 10% to 30% | 8, 16 | First receiving manner |
| 30% to 50% | 16 | First receiving manner |
| >50% | 1, 2, 4, 8, 16 | Second receiving manner |

According to Table 1, when the resource occupancy rate is greater than 50%, regardless of the aggregation level, the terminal does not expect to receive the NR PDCCH through the first receiving manner, that is, the terminal expects to receive the NR PDCCH through the second receiving manner, which is beneficial for avoiding a large number of missing of the NR PDCCH missing and ensuring relatively good transmission performance of the PDCCH.

When the resource occupancy rate is less than 10%, regardless of the aggregation level, the terminal does not expect to receive the NR PDCCH through the second receiving manner, that is, the terminal expects to receive the NR PDCCH through the first receiving manner, in order to simplify the processing process.

When the resource occupancy rate is between 10% and 50%:

Two occupancy rate ranges can be constructed: the first occupancy rate range is 10% to 30%, and the second occupancy rate range is 30% to 50%. Further, two level ranges can be constructed, the first level range is greater than or equal to 8, and the second level range is greater than or equal to 16. That is, the upper limit of the first occupancy rate range is less than or equal to the lower limit of the second occupancy rate range, and the lower limit of the first level range is less than or equal to the lower limit of the second level range.

Furthermore, through the pre-defined rule, in response to the resource occupancy rate being within the i-th occupancy rate range and the aggregation level is within the i-th level range, it is not expected to receive the NR PDCCH through the second receiving manner; in response to the resource occupancy rate being within the i-th occupancy rate range and the aggregation level is outside the i-th level range, it is not expected to receive the NR PDCCH through the first receiving manner. In Table 1, i can be equal to 1 or 2.

For example, when the resource occupancy rate is between 30% and 50%, and the aggregation level is 16 (i.e., in the range greater than or equal to 16), the resource occupancy rate is in a high range and the aggregation level is also in a high range, and the aggregation level causes the NR PDCCH to occupy relatively more resources. Although the LTE indicator channel occupies more resources, puncturing the NR PDCCH can still leave relatively more NR PDCCH content, so the impact on the NR PDCCH is relatively small. Therefore, the first method of receiving the NR PDCCH can be used to receive the NR PDCCH to simplify the processing process.

When the resource occupancy rate is between 30% and 50%, and the aggregation level is 1, 2, 4, or 8 (i.e., in the range less than 16), the resource occupancy rate is in a high range but the aggregation level is in a low range, the aggregation level causes the NR PDCCH to occupy relatively less resources, and the LTE indicator channel occupies more resources. After puncturing the NR PDCCH, there will be relatively less NR PDCCH content left, which has a significant impact on the NR PDCCH. Therefore, the second receiving manner can be used to receive the NR PDCCH, which is conducive to avoiding a large number of missing of the NR PDCCH and ensuring relatively good transmission performance of the PDCCH.

When the resource occupancy rate is between 10% and 30%, and the aggregation level is 8 or 16 (i.e., in the range greater than or equal to 8), the resource occupancy rate is in a low range and the aggregation level is in a high range, the aggregation level causes the NR PDCCH to occupy relatively more resources, and the LTE indicator channel occupies relatively less resources. Therefore, after puncturing the NR PDCCH, there is still relatively more NR PDCCH content left, so the impact on the NR PDCCH is relatively small. Therefore, the first method of receiving the NR PDCCH can be used to receive the NR PDCCH to simplify the processing.

When the resource occupancy rate is between 10% and 30%, and the aggregation level is 1, 2, or 4 (i.e., in the range less than 8), the resource occupancy rate is in a low range, but the aggregation level is also in a low range, and the aggregation level makes the NR PDCCH occupy relatively less resources. Although the LTE indicator channel occupies less resources, puncturing the NR PDCCH may still leave relatively less NR PDCCH content, which has a significant impact on the NR PDCCH. Therefore, the second receiving manner can be used to receive the NR PDCCH, which is conducive to avoiding a large number of missing of the NR PDCCH and ensuring relatively good transmission performance of the PDCCH.

It can be understood that each element in Table 1 exists independently, and these elements are listed in the same table as an example, but it does not mean that all elements in the table must exist simultaneously as shown in the table. The value of each element is independent of any other element values in Table 1. Therefore, those skilled in the art can understand that the value of each element in Table 1 are an independent embodiment.

FIG. 11 is a schematic flowchart of a physical downlink control channel transmitting method according to embodiments of the present disclosure. The physical downlink control channel transmitting method shown in the embodiments can be performed by a network device, where the network device can communicate with a terminal. The network device includes but is not limited to a base station in a communication system such as a 4G base station, a 5G base station, or a 6G base station, etc. The terminal includes but is not limited to a communication device such as a mobile phone, a tablet, a wearable device, a sensor, or an Internet of Things (such as NB-IoT, MTC, eMTC) device.

As shown in FIG. 11, the physical downlink control channel transmitting method may include the following steps S901 to S902.

In step S1101, a first resource occupied by an indicator channel in a long term evolution (LTE) system and a second resource occupied by a new radio (NR) physical downlink control channel (PDCCH) are determined.

In step S1102, in response to a conflict between the second resource and the first resource, a transmitting manner for the NR PDCCH is determined.

In step S1003, the NR PDCCH is transmitted according to the transmitting manner.

Where the transmitting manner includes at least one of:
a first transmitting manner: puncturing the NR PDCCH based on the first resource; or
a second transmitting manner: performing rate matching (RM) on the NR PDCCH based on the first resource.

Two possible transmitting manners are listed in the embodiments of the present disclosure to transmit the NR PDCCH. These two transmitting manners do not necessarily have to be used simultaneously, i.e., only one of the above transmitting manners can be supported in a communication network system, or both of the above transmitting manners can be supported simultaneously, or one of the above transmitting manners and another transmitting manner not listed in the embodiments of the present disclosure can be supported.

For example, it can be the coexistence of the two transmitting manners mentioned above. The terminal can determine, based on the communication protocol or base station indication, a receiving manner corresponding to one of the two transmitting manners for receiving. Alternatively, in the embodiments of the present disclosure, there may be only one transmitting manner, and the terminal can directly use a receiving manner corresponding to the transmitting manner for receiving. Alternatively, in the embodiments of the present disclosure, in a communication system, there may be a scenario where one of the two transmitting manners mentioned above coexists with another transmitting manner not listed in the embodiments of the present disclosure. This scenario should also be considered within the protection scope of the embodiments of the present disclosure.

In an embodiment, in response to a conflict between the second resource and the first resource, the network device may use the first transmitting manner to transmit the NR PDCCH, that is, the network device punctures the NR PDCCH based on the first resource, and the corresponding RE is used to transmit the LTE indicator channel. In an embodiment in the present disclosure, the LTE indicator channel may include but is not limited to: PCFICH and/or PHICH.

For an NR network device, the mapping relationship between NR PDCCH and resources can remain unchanged (when there is not any conflict between the first resource and the second resource), but the NR PDCCH needs to be punctured on an RE corresponding to the first resource, such that NR PDCCH will not be transmitted on the RE corresponding to the first resource.

In response to the network device using a first transmitting manner to transmit the PDCCH, the terminal may not consider the existence of the LTE indicator channel when receiving the NR PDCCH, and can transmit the NR PDCCH on the RE where the first resource overlaps the second resource, and detect the NR PDCCH based on this. Alternatively, when receiving NR PDCCH, the terminal can consider the existence of the LTE indicator channel, so as not to receive NR PDCCH on the RE where the first resource overlaps the second resource, and only receive NR PDCCH on an RE where the first resource does not overlap the second resource.

The first transmitting manner can alleviate the interference caused by the LTE indicator channel on receiving of the NR PDCCH by the terminal, which is beneficial for improving the system capacity for the NR PDCCH and enhancing the performance of NR system. Further, this manner has a relatively simple processing procedure and is easy to implement. However, due to the need to perform puncturing in an overlapping part of the RE corresponding to the NR PDCCH and the RE corresponding to the LTE indicator channel, which may result in the loss of the NR PDCCH.

In an embodiment, in the event of a conflict between the second resource and the first resource, if the network device determines to use the second transmitting manner to transmit the NR PDCCH, rate matching can be performed on the NR PDCCH based on the first resource.

For an NR network device, rate matching for the NR PDCCH based on the first resource can map the NR PDCCH to an RE that is not occupied by the LTE indicator channel, thereby changing the mapping relationship between the NR PDCCH and resources (relative to when the first resource and the second resource do not conflict).

In response to the network device using the second transmitting manner to transmit the PDCCH, the terminal can consider the existence of the LTE indicator channel when receiving the NR PDCCH. Since the network device maps the NR PDCCH to the RE without the LTE indicator channel, correspondingly, the terminal detects and receives the NR PDCCH on the RE without transmitting the LTE indicator channel. In an embodiment in the present disclosure, the LTE indicator channel may include, but is not limited to, PCFICH and/or PHICH.

The second transmitting manner can alleviate the interference caused by the LTE indicator channel on receiving of the NR PDCCH by the terminal, which is beneficial for improving the system capacity for the NR PDCCH and enhancing the performance of NR system. This manner can ensure the integrity of the NR PDCCH to the greatest extent possible.

According to the embodiments of the present disclosure, in response to a conflict between the first resource occupied by the LTE indicator channel and the second resource occupied by the NR PDCCH, the NR PDCCH is transmitted through either the first transmitting manner or the second transmitting manner, which can alleviate the problems caused by the conflict between the first resource and the second resource, which is beneficial for improving the system capacity for the NR PDCCH and enhancing the performance of the NR system.

However, it should be noted that the transmitting manner is not limited to the first transmitting manner or the second transmitting manner mentioned above. Other transmitting methods can be selected as needed, and other transmitting methods can also alleviate the problems caused by the conflict between the first resource and the second resource.

In an embodiment, the indicator channel includes at least one of:
physical control format indicator channel (PCFICH); or
physical hybrid automatic repeat request indicator channel (PHICH).

Where the PCFICH can carry a Control Field Indicator (CFI), which is used to indicate the number of OFDM symbols occupied by a control channel (such as the PDCCH, or the PHICH, etc.) in a subframe. For example, an CFI can carry 2 bits of information and be modulated through QPSK.

The PHICH can carry HARQ information, such as HARQ-ACK or HARQ-NACK. The network device can indicate to the terminal through PHICH whether the uplink information has been successfully received, and the terminal determines whether to retransmit the uplink information based on the indication in PHICH.

It should be noted that the embodiments of the present disclosure can be applied not only to situations where the first resource occupied by the LTE indicator channel conflicts with the second resource occupied by the NR PDCCH, but also to situations where the first resource occupied by the LTE CRS conflicts with the second resource occupied by the NR PDCCH. That is, the method can include steps S101a, S102a, and S103a.

In step S101a, a first resource occupied by the Cell-specific Reference Signal (CRS) in a long term evolution (LTE) system and a second resource occupied by a new radio (NR) physical downlink control channel (PDCCH) are determined.

In step S1102a, in response to a conflict between the second resource and the first resource, a transmitting manner for the NR PDCCH is determined.

In step S1003a, the NR PDCCH is transmitted according to the transmitting manner.

Where the transmitting manner includes at least one of:
a first transmitting manner: puncturing the NR PDCCH based on the first resource; or
a second transmitting manner: performing rate matching (RM) on the NR PDCCH based on the first resource.

Where the same explanations and limitations in the above two implementation manners will not be repeated.

In an embodiment, the method further includes: indicating information to the terminal for indicating the first resource. The indication information may be broadcast information or unicast information. The broadcast information can include system information, paging information, etc., and the unicast information can include RRC signaling, DCI, MAC CE, etc. Where the first resource can be the first resource occupied by the indicator channel in the LTE system or the first resource occupied by the CRS in the LTE system.

The following mainly provides an exemplary explanation of the embodiments in the present disclosure when the indication information is RRC signaling.

In an embodiment, when PCFICH is indicated through the RRC signaling, it can be indicated through any field or information element (IE) in the RRC signaling. In an embodiment in the present disclosure, the information element RateMatchPattenLTE-PCFICH in the RRC signaling can be used for indication, or existing elements in the RRC signaling can be reused. RateMatchPattenLTE-PCFICH can include some or all of the following Information Elements (IEs):

| RateMatchPattenLTE-PCIFCH: : = | SEQUENCE{ | |
|---|---|---|
| Uplink-downlink configuration | {0,...,6}, | OPTIONAL, -- Need M |
| Special subframe configuration | {0,...,10}, | OPTIONAL, -- Need M |
| srs-UpPtsAdd | {0,2,4}, | OPTIONAL, -- Need M |

| | |
|---|---|
| PCI | ENUMERATED{0,...,83}, |

}

Where the Uplink-downlink configuration is used to indicate the downlink/uplink subframe configuration in Table 4.2-2 of the 3GPP 36.211 Technical Specification, and can also be named subframe assignment.

The Special subframe configuration is used to indicate the configuration index in List 4.2-1 of the 3GPP 36.211 Technical Specification.

The srs-UpPtsAdd is used to indicate the duration of the Uplink Pilot Time Slot (UpPTS) in the 3GPP 36.211 Technical Specification.

PCI (Physical Cell ID) is used to indicate the physical cell index and has a certain correspondence with the physical cell index.

In Need M, M represents Maintain, and Need M represents that when the corresponding domain does not exist, it needs to be stored by the user equipment (UE).

It should be noted that the IE included in RateMatchPattenLTE-PCFICH is not limited to the above-mentioned IEs. In some embodiments, other IEs can also be included. For example, when RateMatchPattenLTE-CRS is not configured with mbsfn-SubframeConfigList, RateMatchPattenLTE-PCFICH can include mbsfn-SubframeConfigList. It should be noted that RateMatchPattenLTE-PCFICH can include one or more of the IEs mentioned above, as well as other IEs.

In an embodiment, when the PHICH is indicated through RRC signaling, the information element RateMatchPattenLTE-PHICH in RRC signaling can be defined for indication. RateMatchPattenLTE-PHICH may include some or all of the following information elements (IEs):

| | |
|---|---|
| RateMatchPattenLTE-PHICH: : = | SEQUENCE{ |
| PHICH duration | {normal , extend} |
| phich-Resource | ENUMERATED{oneSixth , half , one , two}, |

}

Where Phich duration is used to indicate the duration of PHICH, for example, refer to Table 6.9.3-1 of 3GPP 36.211 Technical Specification.

phich-Resource, the parameter

$${N}_{g} ∈ \{ \frac{1}{6} , \frac{1}{2} , 1 , 2 \} ,$$

is related to the number of configured PHICH groups and can be referred to in clause 6.9 of the 3GPP 36.211 Technical Specification. The value corresponding to oneSixth is ⅙, the value corresponding to half is ½, and so on.

It should be noted that RateMatchPattenLTE-PHICH is not limited to including the two IEs mentioned above, and can also include other IEs.

When RateMatchPattenLTE-PCIFCH includes IEs such as Uplink-downlink configuration, Special subframe configuration, and srs-UpPtsAdd, RateMatchPattenLTE-PHICH can only include two IEs: PHICH duration and phich-Resource; When RateMatchPattenLTE-PCIFCH does not include IEs such as Uplink-downlink configuration, Special subframe configuration, and srs-UpPtsAdd mentioned above, RateMatchPattenLTE-PHICH can also include IEs such as Uplink-downlink configuration, Special subframe configuration, and srs-UpPtsAdd.

Where the network device can indicate LTE CRS to the terminal.

In an embodiment, the network device can indicate not only the first resources occupied by PCFICH or PHICH, but also the resource occupied by LTE CRS.

For example, when the resource occupied by LTE CRS is indicated through RRC signaling, it can be indicated through any field or information element IE in the RRC signaling. In an embodiment in the present disclosure, information element RateMatchPattenLTE-CRS in RRC signaling can be used for indication. The RateMatchPattenLTE-CRS may include some or all of the following IEs:

| | |
|---|---|
| RateMatchPattenLTE-CRS: : = | SEQUENCE{ |
| carrierFreqDL | INTEGER(0...16383) |
| carrierBandwidthDL | NUMERATED{ n6 , n15 , n25 , n50 , n75 , n100 , |

spare2 , spare1}

| | |
|---|---|
| mbsfn-SubframeConfigList | EUTRA-MBSFN-SubframeConfigList |

OPTINAL, --Need M

| | |
|---|---|
| nrofCRS-Ports | NUMERATED{ n1 , n2 , n4 } |
| v_Shift | NUMERATED{ n0 , n1 , n2 , n3 , n4 , n5 } |

}

Where carrierFreqDL represents the number of subcarrier offsets between the LTE carrier center and the reference point (e.g., point A).

CarrierBandwidthDL represents the configured LTE carrier bandwidth.

The mbsfn-SubframeConfigList represents the subframe configuration of the Multicast Broadcast Single Frequency Network (MBSFN).

nrofCRS-Ports represents the number (e.g., 1, 2, or 4) of antenna ports corresponding to LTE CRS.

ν-Shift represents LTE CRS frequency domain subcarrier offset ν_{shift}.

The following embodiments are mainly illustrated in the case where the first resource occupied by the LTE indicator channel conflicts with the second resource occupied by the NR PDCCH.

Due to the existence of indicator channels such as PCFICH and PHICH, when the RE occupied by the indicator channel overlaps the RE occupied by the NR PDCCH, there is a conflict between the first resource occupied by the indicator channel and the second resource occupied by the NR PDCCH, which interferes with the terminal's receiving of the NR PDCCH.

In an embodiment, the method further includes: indicating information to the terminal for indicating the first resource. The indication information may be broadcast information or unicast information. The broadcast information can include system information, paging information, etc., and the unicast information can include RRC signaling, DCI, MAC CE, etc.

In an embodiment, determining the transmitting manner for the NR PDCCH includes: determining the transmitting manner for the NR PDCCH based on the implementation of the network device; and/or determining the transmitting manner for the NR PDCCH according to a predefined rule.

The network device can determine the transmitting manner for the NR PDCCH based on its own implementation, and transmit an indication (such as RRC signaling, DCI, MAC CE, etc.) indicating the corresponding NR PDCCH receiving manner to the terminal, such that the terminal can determine whether to receive NR PDCCH through the first receiving manner or the second receiving manner according to the indication from the network device.

The Network device can also determine whether to transmit NR PDCCH through the first transmitting method or the second transmitting method based on a predefined rule, such as a protocol agreement.

The following examples illustrate how the network device determines the transmitting manner for the NR PDCCH based on a predefined rule. The description of the first receiving manner and the second receiving manner can refer to other embodiments in the present disclosure and will not be repeated here.

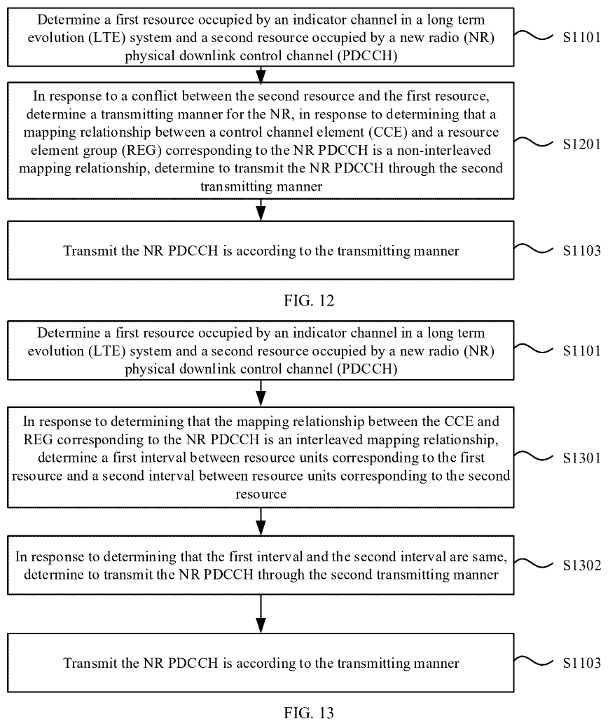

FIG. 12 is a schematic flowchart of another physical downlink control channel transmitting method according to embodiments of the present disclosure. As shown in FIG. 12, determining the transmitting manner of the NR PDCCH according to the predefined rule includes step S1201.

In step S1201, in response to a mapping relationship between a control channel element (CCE) and a resource element group (REG) corresponding to the NR PDCCH being a non-interleaved mapping relationship, it is determined to transmit the NR PDCCH through the second transmitting manner.

In an embodiment, when the mapping relationship between the CCE and REG corresponding to the NR PDCCH is a non-interleaved mapping relationship, the REGs that make up the NR PDCCH are continuous in the time-frequency domain. According to FIG. 3, it can be seen that the resources occupied by the indicator channel are also largely continuous. If the first transmitting manner is used to transmit the NR PDCCH and the NR PDCCH is punctured based on the first resource, it will result in puncturing the NR PDCCH within the continuous resource range, causing a large amount of missing information in the DCI carried by the NR PDCCH, which has a relatively serious impact on the transmission performance of the PDCCH.

According to this embodiment, the predefined rule can stipulate that when the mapping relationship between the CCE and REG corresponding to NR PDCCH is a non-interleaved mapping relationship, the network transmits the NR PDCCH through the second transmitting manner. When the network device determines that the mapping relationship between the CCE and REG corresponding to the NR PDCCH is a non-interleaved mapping relationship, the terminal transmits the NR PDCCH through the second transmitting manner to avoid causing a large amount of missing information in the DCI carried by the NR PDCCH, which seriously affects the transmission performance of the PDCCH.

FIG. 13 is a schematic flowchart of still another physical downlink control channel transmitting method according to embodiments of the present disclosure. As shown in FIG. 13, determining the transmitting manner of the NR PDCCH according to the predefined rule includes steps S1301 and S1302.

In step S1301, in response to the mapping relationship between the CCE and REG corresponding to the NR PDCCH being an interleaved mapping relationship, a first interval between resource units corresponding to the first resource and a second interval between resource units corresponding to the second resource are determined.

In step S1302, in response to the first interval and the second interval being same, it is determined to transmit the NR PDCCH through the second transmitting manner. For example, the first interval can be measured based on the number of RBs or REGs, and when the number is greater than 1, in response to the first interval being the same as the second interval, it is determined to transmit the NR PDCCH through the second transmitting manner.

In an embodiment, when the mapping relationship between the CCE and the REG corresponding to the NR PDCCH is an interleaved mapping relationship, as shown in FIG. 6B, the REGs that make up the NR PDCCH may be discontinuous in some cases.

According to this embodiment, the first interval between resource units corresponding to the first resource and the second interval between resource units corresponding to the second resource can be determined, where the resource units can be PRBs, REGs, REG bundles, etc., to determine whether the first interval and the second interval are the same.

According to FIG. 3, it can be seen that the resources occupied by the indicator channel are largely continuous, but there are also discontinuous parts. If the first interval (for example, the first interval between resource units corresponding to PCFICH in FIG. 3 is 6 REGs) between resource units in the first resource occupied by the LTE indicator channel is exactly the same as the second interval (under the parameter configuration, the second interval is also 6 REGs) between resource units in the second resource occupied by the NR PDCCH, the first receiving manner is adopted to receive the NR PDCCH and the second resource occupied by the NR PDCCH is punctured based on the first resource, which may result in a large amount of missing information in the DCI carried by the NR PDCCH, and have a relatively serious impact on the transmission performance of the PDCCH.

Therefore, according to this embodiment, the predefined rule can stipulate that the mapping relationship between the CCE and REG corresponding to the NR PDCCH is an interleaved mapping relationship, and in response to the first interval being the same as the second interval, the network device transmits the NR PDCCH through the second transmitting manner, or other methods other than the first transmitting manner can be used to transmit the NR PDCCH. When the network device determines that the mapping relationship between the CCE and REG corresponding to the NR PDCCH is an interleaved mapping relationship, and the first interval is the same as the second interval, the network device transmits the NR PDCCH through the second transmitting manner to avoid causing a large number of missing of the NR PDCCH in some resources, which seriously affects the transmission performance of the PDCCH.

In addition, when the first interval is different from the second interval, the NR PDCCH can be transmitted through the first transmitting manner or received through the second receiving manner.

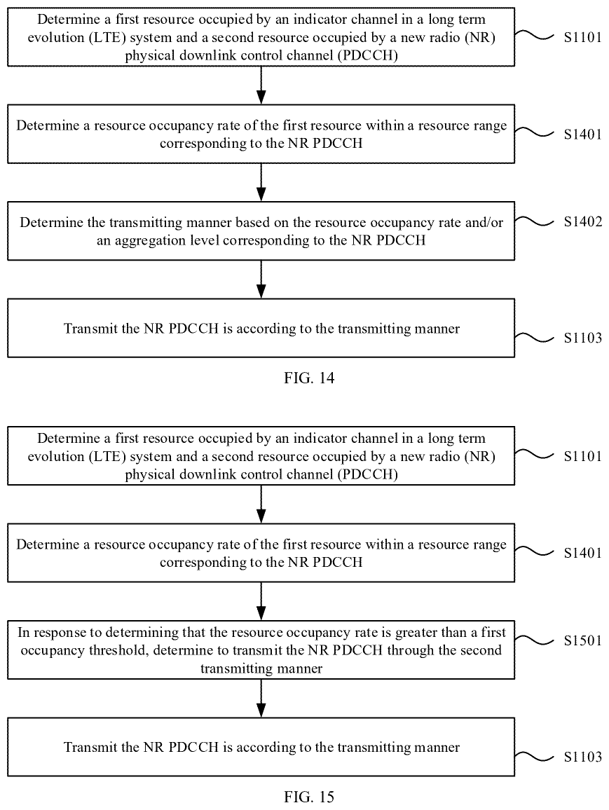

FIG. 14 is a schematic flowchart of still another physical downlink control channel transmitting method according to embodiments of the present disclosure. As shown in FIG. 14, determining the transmitting manner of the NR PDCCH according to the predefined rule includes steps S1401 and S1402.

In step S1401, a resource occupancy rate of the first resource within a resource range corresponding to the NR PDCCH is determined.

In step S1402, the transmitting manner is determined based on the resource occupancy rate and/or an aggregation level corresponding to the NR PDCCH.

In an embodiment, the resource occupancy rate of the first resource within the resource range corresponding to the NR PDCCH can be determined, where the resource occupancy rate is the ratio of the number of some or all resource units corresponding to the first resource to the number of some or all resource units in the resource range. The resource range is the resource occupied by the control resource set (CORESET), or the bandwidth part (BWP) where the NR PDCCH is located, or the resource occupied by the NR PDCCH.

The resource unit includes but is not limited to an RE, an RB, an REG, an REG bundle. The resource range can be all or part of the resources in the CORESET where the NR PDCCH is located, or all or part of the resources in the BWP where the NR PDCCH is located, or all or part of the resources (such as those corresponding to the aggregation level) occupied by the NR PDCCH. Part of resources can be resources corresponding to partial frequency domain and/or partial time domain, and part of resource units can be resource units corresponding to partial frequency domain and/or partial time domain.

considering PCFICH and PHICH, according to FIG. 3, on the first OFDM symbol of the LTE time slot, PCFICH is stored in between 4 RBs and occupies 4 REs in each RB. Therefore, the first resource occupied by PCFICH is 4*4=16 [symbol] RE. The first resource occupied by 7 PHICH groups, each occupying 4 REs, is 4*7=28 REs. So the first resource occupied by the two indicator channels is 42 REs, and it can be determined that the resource occupancy rate in the first OFDM symbol, corresponding to 25 RBs (which can be the RBs corresponding to BWP), is 42/(12*25), which is equal to 14%. That is: Resource occupancy rate=(number of REs occupied by PCFICH+number of REs occupied by PCFICH)+total number of REs.

Considering PCFICH, PHICH, and LTE CRS, for example, based on the embodiment shown in FIG. 3, LTE CRS corresponds to 4 ports and occupies 4 REs in each RB corresponding to the first symbol, and then it can be determined that the first resource occupied by LTE CRS in
RBs is 4*25=100 REs. The first resource occupied by the two indicator channels and LTE CRS is 42+100=142 REs. So the resource occupancy rate in the first OFDM symbol, corresponding to 25 RBs, is 142/(12*25), which is equal to 47%. That is: Resource occupancy rate=(number of REs occupied by PCFICH+number of REs occupied by PCFICH+number of REs occupied by LTE CRS)+total number of REs.

Taking the resources corresponding to the three symbols in CORESET as an example,
considering PCFICH and PHICH, according to FIG. 3, on the first OFDM symbol of the LTE time slot, PCFICH is stored in 4 RBs and occupies 4 REs in each RB. Therefore, the first resource occupied by PCFICH is 4*4=16 REs. The first resource occupied by 7 PHICH groups, each occupying 4 REs, is 4*7=28 REs. Similarly, on the second symbol or the third symbol, the first resource occupied by PHICH is also 4*7=28 REs. Therefore, on the three symbols, the first resource occupied by PHICH is 28*3=84 REs. The first resource occupied by the two indicator channels is 100 REs. Therefore, it can be determined that the resource occupancy rate in the three integrated sensing symbols, each corresponding to the 25 RBs, is 100/(3*12*25), which is approximately equal to 11%. That is: Resource occupancy rate=(number of REs occupied by PCFICH+number of REs occupied by PCFICH)+total number of REs.

Considering PCFICH, PHICH, and LTE CRS, for example, based on the embodiment shown in FIG. 3, LTE CRS corresponds to 4 ports and occupies 4 REs in each RB corresponding to the first symbol, and then it can be determined that the first resource occupied by LTE CRS in 25 RBs is 4*25=100 REs. Similarly, the first resource occupied by LTE CRS in the second symbol is also 100 REs, and there is no LTE CRS in the third symbol. So on the three OFDM symbols, the first resource occupied by the two indicator channels and LTE CRS is 100+2*100=300 REs. So it can be determined that the resource occupancy rate in the three OFDM symbols, each corresponding to 25 RBs, is 300/(3*12*25), which is equal to 33%. That is: Resource occupancy rate=(number of REs occupied by PCFICH+number of REs occupied by PCFICH+number of REs occupied by LTE CRS)+total number of REs.

As the resource occupancy rate increases, there may be more overlap between the first resource and the second resource. Therefore, using the first transmitting manner to transmit the NR PDCCH may result in a large number of NR PDCCHs being missing, seriously affecting the transmission performance of PDCCH. Therefore, the predefined rule can stipulate that the higher the resource occupancy rate, the more inclined the network device is to transmit the NR PDCCH through the second transmitting manner, which is conducive to avoiding a large number of missing of the NR PDCCH and ensuring relatively good transmission performance of the PDCCH.

The NR PDCCH is composed of CCEs, and the number of CCEs that make up the NR PDCCH is called the aggregation level (AL) (for example, it can be a value of 1, 2, 4, 8, or 16, etc.). The higher the aggregation level, the more resources the NR PDCCH occupies. After puncturing the NR PDCCH, a relatively large amount of NR PDCCH content can still be left, so the impact on the NR PDCCH is relatively small. Therefore, the predefined rule can stipulate that the higher the aggregation level, the more inclined the network device is to receive the NR PDCCH through the first receiving manner, in order to simplify the processing process.

FIG. 15 is a schematic flowchart of still another physical downlink control channel transmitting method according to embodiments of the present disclosure. As shown in FIG. 15, determining the transmitting manner based on the resource occupancy rate and/or the aggregation level corresponding to the NR PDCCH includes step S1501.

In step S1501, in response to the resource occupancy rate being greater than a first occupancy threshold, it is determined to transmit the NR PDCCH through the second transmitting manner.

In an embodiment, as the resource occupancy rate increases, there may be more overlap between the first resource and the second resource. Therefore, using the first transmitting manner to transmit the NR PDCCH may result in a large number of NR PDCCHs being missing, seriously affecting the transmission performance of PDCCH.

Therefore, the predefined rule can stipulate that when the resource occupancy rate exceeds the first occupancy rate threshold (which can be set as needed, such as 50%), the network device transmits the NR PDCCH through the second transmitting manner, which is conducive to avoiding a large number of missing of the NR PDCCH and ensuring relatively good transmission performance of the PDCCH.

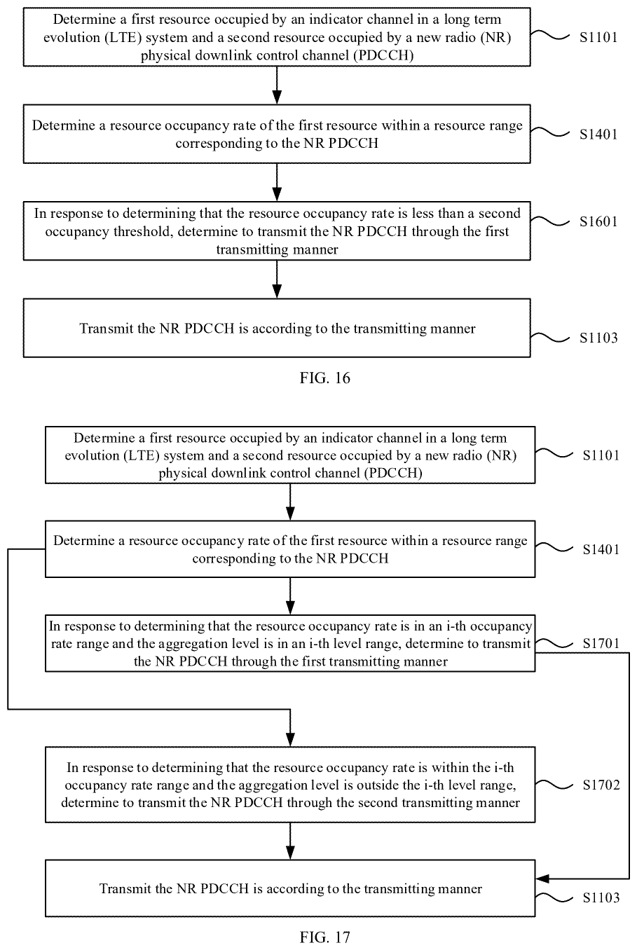

FIG. 16 is a schematic flowchart of still another physical downlink control channel transmitting method according to embodiments of the present disclosure. As shown in FIG. 16, determining the transmitting manner based on the resource occupancy rate and/or the aggregation level corresponding to the NR PDCCH includes step S1601.

In step S1601, in response to the resource occupancy rate being less than a second occupancy threshold, it is determined to transmit the NR PDCCH through the first transmitting manner.

In an embodiment, the lower the resource occupancy rate, the lower the overlap between the first resource and the second resource may be. Therefore, using the first transmitting manner to transmit NR PDCCH will not result in a large number of missing for the NR PDCCH, and seriously affect the transmission performance of PDCCH.

Therefore, the predefined rule can stipulate that when the resource occupancy rate is less than the second occupancy rate threshold (which can be set as needed, such as 10%), the network device transmits the NR PDCCH through the first transmitting manner to simplify the processing process.

FIG. 17 is a schematic flowchart of still another physical downlink control channel transmitting method according to embodiments of the present disclosure. As shown in FIG. 17, determining the transmitting manner based on the resource occupancy rate and/or the aggregation level corresponding to the NR PDCCH includes steps S1701 and S1702.

In step S1701, in response to the resource occupancy rate being in an i-th occupancy rate range and the aggregation level is in an i-th level range, it is determined that the NR PDCCH will be transmitted through through the first transmitting manner.

In step S1702, in response to the resource occupancy rate being within the i-th occupancy rate range and the aggregation level is outside the i-th level range, it is determined that the NR PDCCH will be transmitted through the second transmitting manner.

Where an upper limit of the i-th occupancy rate range is less than or equal to a lower limit of an (i+1)-th occupancy rate range, and a lower limit of the i-th level range is less than or equal to a lower limit of an (i+1)-th level range.

In the embodiments of the present disclosure, the i-th occupancy rate range can be indicated by the base station or determined by the communication protocol. The correspondence between the aggregation level and the level range can be indicated by the base station or determined by the communication protocol. In an embodiment, the correspondence between the aggregation level and the level range can also be determined by the network side device, that is, the network side device determines a corresponding aggregation level based on the current resource occupancy rate being in the i-th occupancy rate range.

In an embodiment, on the one hand, the higher the resource occupancy rate, the more overlapping parts of the first resource and the second resource may be. On the other hand, the higher the aggregation level, the higher the degree of discontinuity of the second resource corresponding to NR PDCCH, and the less overlap it may have with the first resource.

It can be seen that the amount of overlap between the first resource and the second resource is influenced by both the resource occupancy rate and aggregation level. Therefore, the predefined rule can be defined from these two aspects.

For example, n occupancy intervals and n level ranges can be constructed first, where an upper limit of the i-th occupancy rate range is less than or equal to a lower limit of an (i+1)-th occupancy rate range, and a lower limit of the i-th level range is less than or equal to a lower limit of an (i+1)-th level range. Where i and n are positive integers, and i is less than or equal to n.

Furthermore, through the pre-defined rule, in response to the resource occupancy rate being in an i-th occupancy rate range and the aggregation level is in an i-th level range, the NR PDCCH is transmitted through the second transmitting manner.

In response to the resource occupancy rate being within the i-th occupancy rate range and the aggregation level is outside the i-th level range, the NR PDCCH is transmitted through the second transmitting manner.

When the resource occupancy rate is in a high range and the aggregation level is also in a high range, the aggregation level causes the NR PDCCH to occupy relatively more resources. Although the LTE indicator channel occupies more resources, puncturing the NR PDCCH can still leave relatively more NR PDCCH content, so the impact on the NR PDCCH is relatively small. Therefore, the first transmitting manner can be used to transmit the NR PDCCH to simplify the processing process.

When the resource occupancy rate is in a high range but the aggregation level is in a low range, the aggregation level causes the NR PDCCH to occupy relatively less resources, and the LTE indicator channel occupies more resources. After puncturing the NR PDCCH, there will be relatively less NR PDCCH content left, which has a significant impact on the NR PDCCH. Therefore, the second transmitting manner can be used to transmit the NR PDCCH, which is conducive to avoiding a large number of missing of the NR PDCCH and ensuring relatively good transmission performance of the PDCCH.

When the resource occupancy rate is in a low range and the aggregation level is in a high range, the aggregation level causes the NR PDCCH to occupy relatively more resources, and the LTE indicator channel occupies relatively less resources. Therefore, after puncturing the NR PDCCH, there is still relatively more NR PDCCH content left, so the impact on the NR PDCCH is relatively small. Therefore, the first transmitting manner can be used to transmit the NR PDCCH to simplify the processing.

When the resource occupancy rate is in a low range, but the aggregation level is also in a low range, the aggregation level makes the NR PDCCH occupy relatively less resources. Although the LTE indicator channel occupies less resources, puncturing the NR PDCCH may still leave relatively less NR PDCCH content, which has a significant impact on the NR PDCCH. Therefore, the second transmitting manner can be used to transmit the NR PDCCH, which is conducive to avoiding a large number of missing of the NR PDCCH and ensuring relatively good transmission performance of the PDCCH.

In an embodiment, the relationship between the resource occupancy rate, aggregation level, and receiving manner specified by the predefined rule can be shown in Table 1. According to Table 1, when the resource occupancy rate is greater than 50%, regardless of the aggregation level, the terminal does not expect to transmit the NR PDCCH through the first transmitting manner, that is, the terminal expects to transmit the NR PDCCH through the second transmitting manner, which is beneficial for avoiding a large number of missing of the NR PDCCH missing and ensuring relatively good transmission performance of the PDCCH.

When the resource occupancy rate is less than 10%, regardless of the aggregation level, the terminal does not expect to transmit the NR PDCCH through the second transmitting manner, that is, the terminal expects to transmit the NR PDCCH through the first transmitting manner, in order to simplify the processing process.

When the resource occupancy rate is between 10% and 50%:

Two occupancy rate ranges can be constructed: the first occupancy rate range is 10% to 30%, and the second occupancy rate range is 30% to 50%. Further, two level ranges can be constructed, the first level range is greater than or equal to 8, and the second level range is greater than or equal to 16. That is, the upper limit of the first occupancy rate range is less than or equal to the lower limit of the second occupancy rate range, and the lower limit of the first level range is less than or equal to the lower limit of the second level range.

Furthermore, through the pre-defined rule, in response to the resource occupancy rate being within the i-th occupancy rate range and the aggregation level is within the i-th level range, it is not expected to receive the NR PDCCH through the second receiving manner; in response to the resource occupancy rate being within the i-th occupancy rate range and the aggregation level is outside the i-th level range, it is not expected to receive the NR PDCCH through the first receiving manner. In Table 1, i can be equal to 1 or 2.

When the resource occupancy rate is between 30% and 50%, and the aggregation level is 16 (i.e., in the range greater than or equal to 16), the resource occupancy rate is in a high range and the aggregation level is also in a high range, and the aggregation level causes the NR PDCCH to occupy relatively more resources. Although the LTE indicator channel occupies more resources, puncturing the NR PDCCH can still leave relatively more NR PDCCH content, so the impact on the NR PDCCH is relatively small. Therefore, the first transmitting manner can be used to transmit the NR PDCCH to simplify the processing process.

When the resource occupancy rate is between 30% and 50%, and the aggregation level is 1, 2, 4, or 8 (i.e., in the range less than 16), the resource occupancy rate is in a high range but the aggregation level is in a low range, the aggregation level causes the NR PDCCH to occupy relatively less resources, and the LTE indicator channel occupies more resources. After puncturing the NR PDCCH, there will be relatively less NR PDCCH content left, which has a significant impact on the NR PDCCH. Therefore, the second transmitting manner can be used to transmit the NR PDCCH, which is conducive to avoiding a large number of missing of the NR PDCCH and ensuring relatively good transmission performance of the PDCCH.

When the resource occupancy rate is between 10% and 30%, and the aggregation level is 8 or 16 (i.e., in the range greater than or equal to 8), the resource occupancy rate is in a low range and the aggregation level is in a high range, the aggregation level causes the NR PDCCH to occupy relatively more resources, and the LTE indicator channel occupies relatively less resources. Therefore, after puncturing the NR PDCCH, there is still relatively more NR PDCCH content left, so the impact on the NR PDCCH is relatively small. Therefore, the first transmitting manner can be used to transmit the NR PDCCH to simplify the processing.

When the resource occupancy rate is between 10% and 30%, and the aggregation level is 1, 2, or 4 (i.e., in the range less than 8), the resource occupancy rate is in a low range, but the aggregation level is also in a low range, and the aggregation level makes the NR PDCCH occupy relatively less resources. Although the LTE indicator channel occupies less resources, puncturing the NR PDCCH may still leave relatively less NR PDCCH content, which has a significant impact on the NR PDCCH. Therefore, the second transmitting manner can be used to transmit the NR PDCCH, which is conducive to avoiding a large number of missing of the NR PDCCH and ensuring relatively good transmission performance of the PDCCH.

It can be understood that each element in Table 1 exists independently, and these elements are listed in the same table as an example, but it does not mean that all elements in the table must exist simultaneously as shown in the table. The value of each element is independent of any other element values in Table 1. Therefore, those skilled in the art can understand that the value of each element in Table 1 are an independent embodiment.

Corresponding to the embodiments of the physical downlink control channel receiving method and the physical downlink control channel transmitting method mentioned above, the present disclosure further provides embodiments of the physical downlink control channel receiving apparatus and the physical downlink control channel transmitting apparatus.

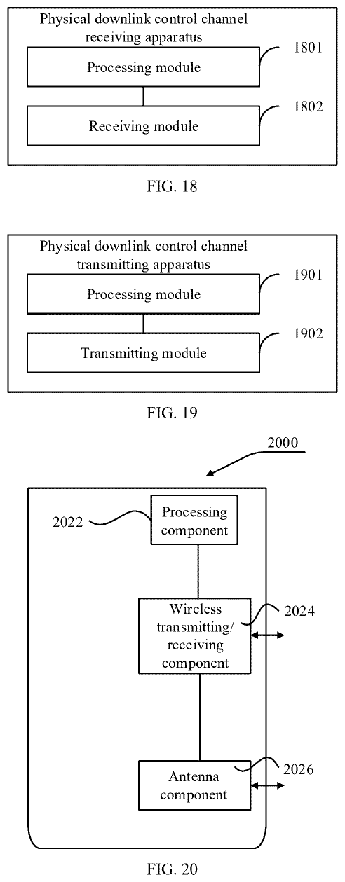

FIG. 18 is a schematic block diagram of a physical downlink control channel receiving apparatus according to embodiments of the present disclosure. The physical downlink control channel receiving apparatus shown in the embodiments can be applied to a terminal. The terminal includes but is not limited to a communication device such as a mobile phone, a tablet, a wearable device, a sensor, or an Internet of Things (IoT) device. The terminal can communicate with a network device. The network device includes but not limited to a network device (such as a base station, a core network, etc.) in a communication system such as a 4G communication system, a 5G communication system, or a 6G communication system, etc.

As shown in FIG. 18, the physical downlink control channel receiving apparatus may include:
a processing module 1801, configured to: determine a first resource occupied by an indicator channel in a long term evolution (LTE) system and a second resource occupied by a new radio (NR) physical downlink control channel (PDCCH); and determine, in response to a conflict between the second resource and the first resource, a receiving manner for the NR PDCCH;
a receiving module 1802, configured to receive the NR PDCCH according to the receiving manner;
where the receiving manner includes at least one of:
a first receiving manner: puncturing the NR PDCCH based on the first resource; or
a second receiving manner: performing rate matching (RM) on the NR PDCCH based on the first resource.

In an embodiment, the indicator channel includes at least one of: a Physical Control Format Indicator Channel (PCFICH); or a Physical Hybrid ARQ Indicator Channel PHICH.

In an embodiment, the processing module is configured to determine the receiving manner for the NR PDCCH based on the indication from the network device; and/or determine the receiving manner for the NR PDCCH according to the predefined rule.

In an embodiment, the processing module is configured to not expect to receive the NR PDCCH through the first receiving manner when the mapping relationship between the control channel element (CCE) and the resource element group (REG) corresponding to the NR PDCCH is a non-interleaved mapping relationship.

In an embodiment, the processing module is configured to determine the first interval between resource units corresponding to the first resource and the second interval between resource units corresponding to the second resource, when the mapping relationship between CCE and REG corresponding to the NR PDCCH is an interleaved mapping relationship; and not expect to receive the NR PDCCH through the first receiving manner when the first interval is the same as the second interval.

In an embodiment, the processing module is configured to determine the resource occupancy rate of the first resource within the resource range corresponding to the NR PDCCH; and determine the receiving manner based on the resource occupancy rate and/or the aggregation level corresponding to the NR PDCCH.

In an embodiment, the resource occupancy rate is a ratio of a number of some or all resource units corresponding to the first resource to a number of some or all resource units in the resource range.

In an embodiment, the resource range is a control resource set (CORESET) where the NR PDCCH is located, or a resource occupied by a bandwidth part (BWP) where the NR PDCCH is located, or a resource occupied by the NR PDCCH.

In an embodiment, the processing module is configured to not expect to receive the NR PDCCH through the first receiving manner when the resource occupancy rate is greater than a first occupancy rate threshold.

In an embodiment, the processing module is configured to not expect to receive the NR PDCCH through the second receiving manner when the resource occupancy rate is less than a second occupancy rate threshold.

In an embodiment, the processing module is configured to not expect to receive the NR PDCCH through the second receiving manner if the resource occupancy rate is in the i-th occupancy rate range and the aggregation level is in the i-th level range;

If the resource occupancy rate is within the i-th occupancy rate range and the aggregation level is outside the i-th level range, or if the resource occupancy rate is outside the i-th occupancy rate range and the aggregation level is within the i-th level range, it is not expected to receive the NR PDCCH through the first receiving manner;
where an upper limit of the i-th occupancy rate range is less than or equal to a lower limit of an (i+1)-th occupancy rate range, and a lower limit of the i-th level range is less than a lower limit of an (i+1)-th level range.

In an embodiment, the processing module is configured to determine the first resource based on the indication information transmitted by the network device.

FIG. 19 is a schematic block diagram of a physical downlink control channel transmitting apparatus according to embodiments of the present disclosure. The physical downlink control channel transmitting apparatus shown in the embodiments can be performed by a network device, where the network device can communicate with a terminal. The network device includes but is not limited to a base station in a communication system such as a 4G base station, a 5G base station, or a 6G base station, etc. The terminal includes but is not limited to a communication device such as a mobile phone, a tablet, a wearable device, a sensor, or an Internet of Things (such as NB-IoT, MTC, eMTC) device.

As shown in FIG. 19, the physical downlink control channel transmitted apparatus may include:
a processing module 1901, configured to: determine a first resource occupied by an indicator channel in a long term evolution (LTE) system and a second resource occupied by a new radio (NR) physical downlink control channel (PDCCH); and determine, in response to a conflict between the second resource and the first resource, a transmitting manner for the NR PDCCH;
a transmitting module 1902, configured to transmit the NR PDCCH according to the transmitting manner;
where the transmitting manner includes at least one of:
a first transmitting manner: puncturing the NR PDCCH based on the first resource; or
a second transmitting manner: performing rate matching (RM) on the NR PDCCH based on the first resource.

In an embodiment, the indicator channel includes at least one of: a Physical Control Format Indicator Channel (PCFICH); or a Physical Hybrid ARQ Indicator Channel PHICH.

In an embodiment, determining the transmitting manner for the NR PDCCH includes: determining the transmitting manner for the NR PDCCH based on the implementation of the network device; and/or determining the transmitting manner for the NR PDCCH according to a predefined rule.

In an embodiment, the processing module is configured to determine to transmit the NR PDCCH through the second transmitting manner when the mapping relationship between the control channel element (CCE) and the resource element group (REG) corresponding to the NR PDCCH is a non-interleaved mapping relationship.

In an embodiment, the processing module is configured to determine the first interval between resource units corresponding to the first resource and the second interval between resource units corresponding to the second resource, when the mapping relationship between CCE and REG corresponding to the NR PDCCH is an interleaved mapping relationship; and not expect to transmit the NR PDCCH through the second transmitting manner when the first interval is the same as the second interval.

In an embodiment, the processing module is configured to determine the resource occupancy rate of the first resource within the resource range corresponding to the NR PDCCH; and determine the transmitting manner based on the resource occupancy rate and/or the aggregation level corresponding to the NR PDCCH.

In an embodiment, the resource occupancy rate is a ratio of a number of some or all resource units corresponding to the first resource to a number of some or all resource units in the resource range.

In an embodiment, the resource range is a control resource set (CORESET) where the NR PDCCH is located, or a resource occupied by a bandwidth part (BWP) where the NR PDCCH is located, or a resource occupied by the NR PDCCH.

In an embodiment, the processing module is configured to determine to transmit the NR PDCCH through the second transmitting manner when the resource occupancy rate is greater than a first occupancy rate threshold.

In an embodiment, the processing module is configured to determine to transmit the NR PDCCH through the first transmitting manner when the resource occupancy rate is less than a second occupancy rate threshold.

In an embodiment, the processing module is configured to determine to transmit the NR PDCCH through the first transmitting manner if the resource occupancy rate is in the i-th occupancy rate range and the aggregation level is in the i-th level range;
if the resource occupancy rate is within the i-th occupancy rate range and the aggregation level is outside the i-th level range, or if the resource occupancy rate is outside the i-th occupancy rate range and the aggregation level is within the i-th level range, determine to transmit the NR PDCCH through the second transmitting manner;
where an upper limit of the i-th occupancy rate range is less than or equal to a lower limit of an (i+1)-th occupancy rate range, and a lower limit of the i-th level range is less than a lower limit of an (i+1)-th level range.

In an embodiment, the transmitting module is further configured to transmit indication information to the terminal for indicating the first resource.

With regard to the device in the above examples, the specific manner in which the respective modules perform the operations has been described in detail in the examples of the related methods, and will not be explained in detail herein.

Since the device embodiments basically corresponds to the method embodiments, the relevant parts can refer to the partial description of the method embodiments. The device examples described above are merely illustrative, where the modules described as separate members may be or not be physically separated, and the members displayed as modules may be or not be physical units, i.e., may be located in one place, or may be distributed in a plurality of network modules. Part or all of the modules may be selected according to actual requirements to implement the objectives of the solutions in the examples. A person skilled in the art can understand and implement without creative work.

The embodiments of the present disclosure further provide a communication device, including: one or more processors; and one or more memories for storing a computer programs; where when the computer program is executed by the one or more processors, the physical downlink control channel receiving method according to any one of the above embodiments is implemented.

The embodiments of the present disclosure further provide a communication device, including: one or more processors; and one or more memories for storing a computer programs; where when the computer program is executed by the one or more processors, the physical downlink control channel transmitting method according to any one of the above embodiments is implemented.

The present embodiments of the present disclosure further provide a computer-readable storage medium for storing a computer program, where when the computer program is executed by one or more processors, the physical downlink control channel receiving method according to any one of the above embodiments is implemented.

The present embodiments of the present disclosure further provide a computer-readable storage medium for storing a computer program, where when the computer program is executed by one or more processors, the physical downlink control channel transmitting method according to any one of the above embodiments is implemented.

As shown in FIG. 20, FIG. 20 is a schematic block diagram of an apparatus 2000 for physical downlink control channel transmission according to embodiments of the present disclosure. The apparatus 2000 may be provided as a base station. Referring to FIG. 20, the apparatus 2000 includes a processing component 2022, a wireless transmitting/receiving component 2024, an antenna component 2026, and a signal processing portion specific to a wireless interface. The processing component 2022 may further include one or more processors. One of the processors in processing component 2022 can be configured to implement the physical downlink control channel transmitting method described in any one of the above embodiments.

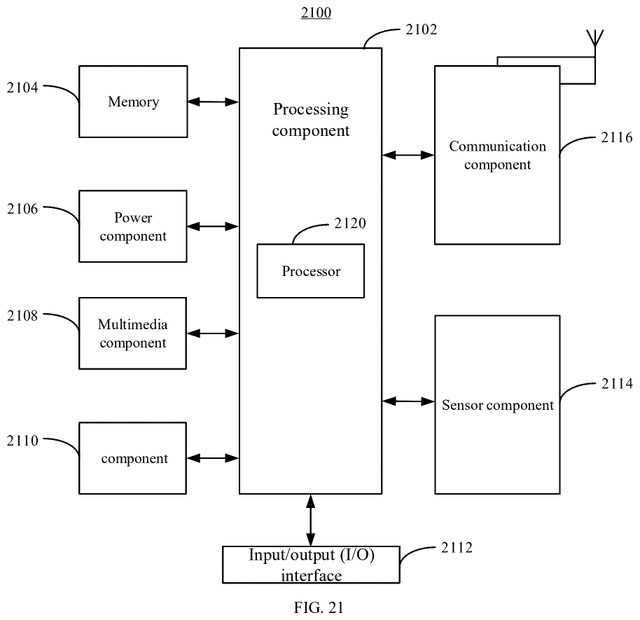

FIG. 21 is a schematic block diagram of a device 2100 for physical downlink control channel receiving according to embodiments of the present disclosure. For example, device 2100 can be a mobile phone, a computer, a digital broadcast terminal, a message transmitting and receiving device, a gaming console, a tablet device, a medical device, a fitness device, a personal digital assistant, and the like.

Referring to FIG. 21, device 2100 can include one or more of the following components: processing component 2102, memory 2104, power supply component 2106, multimedia component 2108, audio component 2110, input/output (I/O) interface 2112, sensor component 2114, or a communication component 2116.

The processing component 2102 generally controls the overall operations of the device 2100, such as operations associated with display, calling, data communication, camera operation and recording operation. The processing component 2102 may include one or more processors 2120 to execute instructions to complete all or part of the steps of the physical downlink control channel receiving method described above. Further, the processing component 2102 may include one or more modules to facilitate interaction between the processing component 2102 and another component. For example, the processing component 2102 may include a multimedia module to facilitate the interaction between the multimedia component 2108 and the processing component 2102.

The memory 2104 is configured to store different types of data to support the operations of the device 2100. Examples of such data include instructions of any application program or method operable on the device 2100, contact data, telephone directory data, messages, pictures, videos, and the like. The memory 2104 may be implemented by any type of volatile or non-volatile storage devices or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a disk or a CD.

The power supply component 2106 provides power for different components of the device 2100. The power supply component 2106 may include a power management system, one or more power sources, and other components associated with generating, managing and distributing power for the device 2100.

The multimedia component 2108 may include a screen for providing an output interface between the device 2100 and a user. In some examples, the screen may include a Liquid Crystal Display (LCD) and a Touch Panel (TP). If the screen includes a touch panel, the screen may be implemented as a touch screen for receiving an input signaling from a user. The touch panel may include one or more touch sensors for sensing a touch, a slide and a gesture on the touch panel. The touch sensor may not only sense a boundary of a touching or sliding movement, but also detect duration and pressure related to the touching or sliding operation. In some examples, the multimedia component 2108 may include a front camera and/or a rear camera. When the device 2100 is in an operation mode, such as a shooting mode or a video mode, the front camera and/or the rear camera can receive external multimedia data. Each of the front camera and the rear camera may be a fixed optical lens system or be of a focal length and a capability of an optical zoom.

The audio component 2110 is configured to output and/or input an audio signaling. For example, the audio component 2110 may include a microphone (MIC). When the device 2100 is in an operating mode, such as a call mode, a recording mode and a speech recognition mode, the microphone is configured to receive an external audio signal. The received audio signaling may be further stored in the memory 2104 or transmitted via the communication component 2116. In some examples, the audio component 2110 also includes a loudspeaker for outputting an audio signaling.

The I/O interface 2112 provides an interface between the processing component 2102 and a peripheral interface module which may be a keyboard, a click wheel, a button, or the like. These buttons may include but not limited to, a home button, a volume button, a start button and a lock button.

The sensor component 2114 may include one or more sensors for providing state assessments in different aspects for the device 2100. For example, sensor component 2114 can detect an open/closed state of device 2100, a relative positioning of components, such as the display and keypad of device 2100, and sensor component 2114 can also detect a change in position of device 2100 or a component of device 2100, the existence or absence of user contact with device 2100, orientation or acceleration/deceleration of device 2100, and temperature change of device 2100. The sensor component 2114 may include a proximity sensor for detecting the existence of a nearby object without any physical touch. The sensor component 2114 may also include an optical sensor, such as a CMOS or CCD image sensor used in an imaging application. In some examples, the sensor component 2114 may also include an acceleration sensor, a gyro sensor, a magnetic sensor, a pressure sensor, or a temperature sensor.

The communication component 2116 is configured to facilitate wired or wireless communication between the device 2100 and other devices. The device 2100 may access a wireless network according to a communication standard, such as WiFi, 2G, 3G, 4G LTE, 5G NR, or a combination thereof. In some embodiments, the communication component 2116 may receive a broadcast signaling or broadcast-related information from an external broadcast management system via a broadcast channel. In an example, the communication component 2116 may also include a Near Field Communication (NFC) module to facilitate short-range communications. For example, the NFC module may be implemented according to a Radio Frequency Identification (RFID) technology, an Infrared Data Association (IrDA) technology, an Ultra Wideband (UWB) technology, a Bluetooth® (BT) technology and other technologies.

In an example, the device 2100 may be implemented by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), controllers, microcontrollers, microprocessors, or other electronic components for performing the physical downlink control channel receiving method described above.

In an example, a non-transitory computer readable storage medium including instructions, such as the memory 2104 including instructions, is also provided. The above instructions may be executed by the processor 2120 of the device 2100 to complete the above physical downlink control channel receiving method. For example, the non-transitory computer-readable storage medium may be a ROM, a RAM, a CD-ROM, a magnetic tape, a floppy disc, an optical data storage device, and the like.

After considering and practicing the disclosure of the specification, other embodiments of the present disclosure will be readily apparent to those skilled in the art. The present disclosure is intended to cover any modification, use or adaptation of the present disclosure. These modifications, uses or adaptations follow the general principles of the present disclosure and include common knowledge and conventional technical means in the technical field that are not disclosed in the present disclosure. The specification and embodiments herein are intended to be illustrative only and the real scope and spirit of the present disclosure are indicated by the following claims of the present disclosure.

It is to be understood that the present disclosure is not limited to the precise structures described above and shown in the accompanying drawings and may be modified or changed without departing from the scope of the present disclosure. The scope of protection of the present disclosure is limited only by the appended claims.

It is to be noted that the relational terms such as “first” and “second” used herein are merely intended to distinguish one entity or operation from another entity or operation rather than to require or imply any such actual relation or order existing between these entities or operations. The term “including”, “containing” or any variation thereof is intended to encompass non-exclusive inclusion, so that a process, method, article or device including a series of elements includes not only those elements but also other elements not listed explicitly or those elements inherent to such a process, method, article or device. Without further limitation, the element defined by the statement “including a . . . ” do not preclude the existence of additional identical elements in the process, method, article, or device that include the element.

The above provides a detailed introduction to the methods and apparatuses provided in the embodiments of the present disclosure. Specific examples are applied in the present disclosure to explain the principles and embodiments of the present disclosure. The explanations of the above embodiments are only used to help understand the methods and core ideas of the present disclosure. Meanwhile, for those skilled in the art, based on the idea of the present disclosure, there will be changes in the embodiments and application scopes. In summary, the content of the specification should not be construed as limiting the present disclosure.

1. A method for receiving a physical downlink control channel; performed by a terminal, the method comprising:
determining a first resource occupied by an indicator channel in a long term evolution (LTE) system and a second resource occupied by a new radio (NR) physical downlink control channel (PDCCH);
determining, wherein there is a conflict between the second resource and the first resource, a receiving manner for the NR PDCCH; and
receiving the NR PDCCH according to the receiving manner;
wherein the receiving manner comprises at least one of:
a first receiving manner: receiving based on puncturing of the NR PDCCH by a network device according to the first resource; or
a second receiving manner: receiving based on rate matching of the NR PDCCH by a network device according to the first resource.

2. The method according to claim 1, wherein the indicator channel comprises at least one of:
physical control format indicator channel (PCFICH); or
physical hybrid automatic repeat request indicator channel (PHICH).

3. The method according to claim 1, wherein determining the receiving manner for the NR PDCCH comprises:
determining the receiving manner for the NR PDCCH according to an indication from the network device; and/or
determining the receiving manner for the NR PDCCH according to a predefined rule.

4. The method according to claim 3, wherein determining the receiving manner for the NR PDCCH according to the predefined rule comprises:
wherein a mapping relationship between a control channel element (CCE) and a resource element group (REG) corresponding to the NR PDCCH is a non-interleaved mapping relationship, not expecting to receive the NR PDCCH through the first receiving manner.

5. The method according to claim 3, wherein determining the receiving manner for the NR PDCCH according to the predefined rule comprises:
wherein a mapping relationship between a CCE and an REG corresponding to the NR PDCCH is an interleaved mapping relationship, determining a first interval between resource units corresponding to the first resource and a second interval between resource units corresponding to the second resource; and
wherein the first interval and the second interval are same, not expecting to receive the NR PDCCH through the first receiving manner.

6. The method according to claim 3, wherein determining the receiving manner for the NR PDCCH according to the predefined rule comprises:
determining a resource occupancy rate of the first resource within a resource range corresponding to the NR PDCCH; and
determining the receiving manner based on the resource occupancy rate and/or an aggregation level corresponding to the NR PDCCH.

7. The method according to claim 6, wherein the resource occupancy rate is a ratio of a number of some or all resource units corresponding to the first resource to a number of some or all resource units in the resource range.

8. The method according to claim 7, wherein the resource range is a control resource set (CORESET) where the NR PDCCH is located, or a resource occupied by a bandwidth part (BWP) where the NR PDCCH is located, or a resource occupied by the NR PDCCH.

9. The method according to claim 6, wherein determining the receiving manner based on the resource occupancy rate and/or the aggregation level corresponding to the NR PDCCH comprises:
wherein the resource occupancy rate is greater than a first occupancy rate threshold, not expecting to receive the NR PDCCH through the first receiving manner.

10. The method according to claim 6, wherein determining the receiving manner based on the resource occupancy rate and/or the aggregation level corresponding to the NR PDCCH comprises:
wherein the resource occupancy rate is less than a second occupancy rate threshold, not expecting to receive the NR PDCCH through the second receiving manner.

11. The method according to claim 6, wherein determining the receiving manner based on the resource occupancy rate and/or the aggregation level corresponding to the NR PDCCH comprises:
wherein the resource occupancy rate is in an i-th occupancy rate range and the aggregation level is in an i-th level range, not expecting to receive the NR PDCCH through the second receiving manner;
wherein the resource occupancy rate is within the i-th occupancy rate range and the aggregation level is outside the i-th level range, not expecting to receive the NR PDCCH through the first receiving manner;
wherein an upper limit of the i-th occupancy rate range is less than or equal to a lower limit of an (i+1)-th occupancy rate range, and a lower limit of the i-th level range is less than or equal to a lower limit of an (i+1)-th level range.

12. The method according to claim 1, wherein determining the first resource occupied by the indicator channel in the long term evolution (LTE) system comprises:
determining the first resource based on indication information transmitted by the network device.

13. A method for transmitting a physical downlink control channel performed by a network device, the method comprising:
determining a first resource occupied by an indicator channel in a long term evolution (LTE) system and a second resource occupied by a new radio (NR) physical downlink control channel (PDCCH);
determining, wherein there is a conflict between the second resource and the first resource, a transmitting manner for the NR PDCCH; and
transmitting the NR PDCCH according to the transmitting manner;
wherein the transmitting manner comprises at least one of:
a first transmitting manner: puncturing the NR PDCCH based on the first resource; or
a second transmitting manner: performing rate matching (RM) on the NR PDCCH based on the first resource.

14. The method according to claim 13, wherein the indicator channel comprises at least one of:
physical control format indicator channel (PCFICH); or
physical hybrid automatic repeat request indicator channel (PHICH).

15. The method according to claim 13, wherein determining the transmitting manner for the NR PDCCH comprises:
determining the transmitting manner for the NR PDCCH based on implementation of the network device; and/or
determining the transmitting manner for the NR PDCCH according to a predefined rule.

16. The method according to claim 15, wherein determining the transmitting manner for the NR PDCCH according to the predefined rule comprises:
wherein a mapping relationship between a control channel element (CCE) and a resource element group (REG) corresponding to the NR PDCCH is a non-interleaved mapping relationship, determining to transmit the NR PDCCH through the second transmitting manner.

17-26. (canceled)

27. A communication device, comprising:
one or more processors; and
one or more memories for storing a computer programs;
wherein when the computer program is executed by the one or more processors, cause the communication device to perform a method comprising:
determining a first resource occupied by an indicator channel in a long term evolution (LTE) system and a second resource occupied by a new radio (NR) physical downlink control channel (PDCCH);
determining, wherein there is a conflict between the second resource and the first resource, a receiving manner for the NR PDCCH; and
receiving the NR PDCCH according to the receiving manner;
wherein the receiving manner comprises at least one of:
a first receiving manner: receiving based on puncturing of the NR PDCCH by a network device according to the first resource; or
a second receiving manner: receiving based on rate matching of the NR PDCCH by a network device according to the first resource.

28. A communication device, comprising:
one or more processors; and
one or more memories for storing a computer programs;
wherein the computer program is executed by the one or more processors, cause to the communication device to act as the network device and perform the method according to claim 13.

29. A non-transitory computer-readable storage medium storing a computer program, wherein the computer program when executed by one or more processors of the terminal, causes the terminal to perform the method according to claim 1.

30. A non-transitory computer-readable storage medium storing a computer program, wherein the computer program when executed by one or more processors of the network device, cause the network device to perform the method according to claim 13.
